(19) United States
(12) Patent Application Publication
(10) Pub. No.: US 2026/0151996 A1
(43) Pub. Date: Jun. 4, 2026

(54) LIQUID EJECTION APPARATUS AND LIQUID EJECTION UNIT

(71) Applicant: SEIKO EPSON CORPORATION, Tokyo (JP)

(72) Inventors: Tomonori YAMADA, Shiojiri (JP); Naoki YAMAZAKI, Shiojiri (JP)

(21) Appl. No.: 19/404,119

(22) Filed: Dec. 1, 2025

(30) Foreign Application Priority Data
Dec. 3, 2024 (JP) 2024-210111

(51) Int. Cl. B41J 2/045; H01G 9/025; H01G 9/048

(52) U.S. Cl. CPC B41J 2/04548; B41J 2/0451; B41J 2/04541; B41J 2/0455; B41J 2/04581; H01G 9/025; H01G 9/048

(57) ABSTRACT

Provided is a liquid ejection apparatus including: an ejection portion that ejects a liquid; a switch circuit that switches whether or not to supply the drive signal to the ejection portion; and a power supply circuit to which outputs a second power supply voltage signal to the switch circuit, in which the power supply circuit includes a capacitor, the capacitor includes an anode foil in which an oxide film is formed at a surface, a cathode foil, a separator disposed between the anode foil and the cathode foil, and an electrolyte existing in a gap portion except for the separator between the anode foil and the cathode foil, and the electrolyte includes a solid electrolyte phase containing a conductive polymer compound, and a liquid substance phase that exists so as to surround the solid electrolyte phase and contains a liquid substance.

### The present application is based on, and claims priority from JP Application Serial Number 2024-210111, filed Dec. 3, 2024, the disclosure of which is hereby incorporated by reference herein in its entirety.

### BACKGROUND

### 1. Technical Field

The present disclosure relates to a liquid ejection apparatus and a liquid ejection unit.

### 2. Related Art

JP-A-2024-052282 discloses a liquid ejection apparatus that forms an image on a medium by causing an ejected liquid to land on the medium, the liquid ejection apparatus including a power supply circuit that converts a voltage value of an input power supply voltage into a voltage signal having a desired voltage value used in each portion of the liquid ejection apparatus. In the power supply circuit included in such a liquid ejection apparatus, a switching power supply circuit is widely used from the viewpoint of reducing power consumption of the liquid ejection apparatus.

However, in the liquid ejection apparatus in which a switching power supply is used as a power supply circuit, from the viewpoint of improving stability of an operation of the liquid ejection apparatus, the technology described in JP-A-2024-052282 is not sufficient, and there is room for improvement.

### SUMMARY

According to an aspect of the present disclosure, there is provided a liquid ejection apparatus including:
a transport portion that transports a medium;
an ejection portion that ejects a liquid to the medium by being supplied with a drive signal;
a first switch circuit that switches whether or not to supply the drive signal to the ejection portion; and
a power supply circuit to which a first power supply voltage signal is input and which outputs a second power supply voltage signal to the first switch circuit, in which
the power supply circuit includes
   a switching circuit that outputs a pulse signal corresponding to the first power supply voltage signal, and
   a smoothing circuit that includes a capacitor and outputs the second power supply voltage signal obtained by smoothing the pulse signal,
the capacitor includes an anode foil in which an oxide film is formed at a surface, a cathode foil, a separator disposed between the anode foil and the cathode foil, and an electrolyte existing in a gap portion except for the separator between the anode foil and the cathode foil, and
the electrolyte includes a solid electrolyte phase containing a conductive polymer compound, and a liquid substance phase that exists so as to surround the solid electrolyte phase and contains a liquid substance.

According to another aspect of the present disclosure, there is provided a liquid ejection unit including:
an ejection portion that ejects a liquid to a medium by being supplied with a drive signal;
a first switch circuit that switches whether or not to supply the drive signal to the ejection portion; and
a power supply circuit to which a first power supply voltage signal is input and which outputs a second power supply voltage signal to the first switch circuit, in which
the power supply circuit includes
   a switching circuit that outputs a pulse signal corresponding to the first power supply voltage signal, and
   a smoothing circuit that includes a capacitor and outputs the second power supply voltage signal obtained by smoothing the pulse signal,
the capacitor includes an anode foil in which an oxide film is formed at a surface, a cathode foil, a separator disposed between the anode foil and the cathode foil, and an electrolyte existing in a gap portion except for the separator between the anode foil and the cathode foil, and
the electrolyte includes a solid electrolyte phase containing a conductive polymer compound, and a liquid substance phase that exists so as to surround the solid electrolyte phase and contains a liquid substance.

### BRIEF DESCRIPTION OF THE DRAWINGS

FIG. 1 is a view illustrating a schematic configuration of a liquid ejection apparatus.

FIG. 2 is a view illustrating an example of a functional configuration of an ejection unit.

FIG. 3 is a view illustrating a schematic structure of an ejection portion.

FIG. 4 is a view illustrating an example of a functional configuration of a print head.

FIG. 5 is a view illustrating an example of a configuration of a switch.

FIG. 6 is a view illustrating an example of various signals input to a coupling state designation circuit.

FIG. 7 is a view illustrating an example of a configuration of a waveform shaping circuit.

FIG. 8 is a view illustrating an example of various signals output by a control circuit in a period in which an ejection process is executed.

FIG. 9 is a view illustrating an example of a relationship between an individual designation signal and a coupling state designation signal in a period in which the ejection process is executed.

FIG. 10 is a view illustrating an example of various signals input to a supply switching circuit of the print head in a period in which a determination process is executed.

FIG. 11 is a view illustrating an example of a relationship between an individual designation signal and coupling state designation signals in a period in which the determination process is executed.

FIG. 12 is a view illustrating an example of a relationship between the individual designation signal and the coupling state designation signals in a period in which the determination process is executed.

FIG. 13 is a view illustrating an example of an acquisition operation of a detection potential signal based on a signal corresponding to residual vibration generated in an ejection portion that is an inspection target.

FIG. 14 is a view illustrating an example of a functional configuration of a power supply circuit.

FIG. 15 is a cross-sectional view of a capacitor.

FIG. 16 is a partially exploded perspective view of a capacitor element included in the capacitor.

FIG. 17 is a cross-sectional view illustrating a main portion of the capacitor.

### DESCRIPTION OF EMBODIMENTS

Hereinafter, appropriate embodiments of the present disclosure will be described with reference to the drawings. The drawings to be used are for convenience of description. Note that the embodiments to be described below do not inappropriately limit the contents of the present disclosure described in the appended claims. In addition, not all of the configurations to be described below are necessarily essential components of the present disclosure.

### 1. Configuration of Liquid Ejection Apparatus

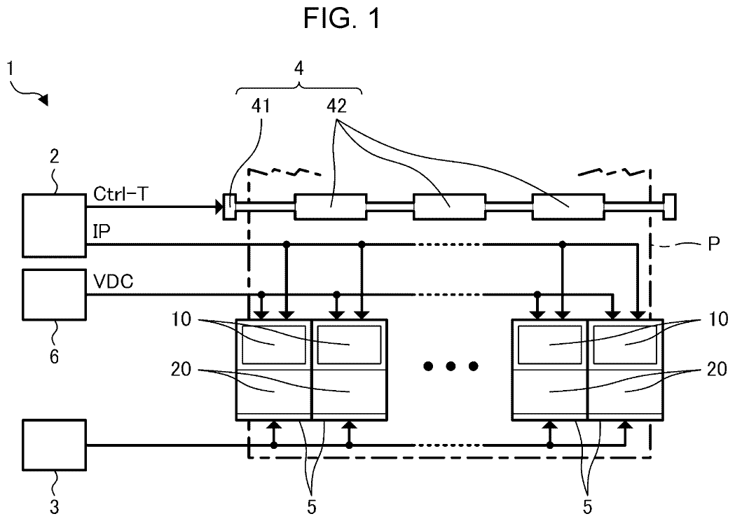

FIG. 1 is a view illustrating a schematic configuration of a liquid ejection apparatus 1. The liquid ejection apparatus 1 of the present embodiment is a so-called line-type ink jet printer that forms a desired image on a medium P by ejecting ink as an example of a liquid from each of a plurality of ejection units 5 at a desired timing with respect to the medium P transported by a transport unit 4. Note that the liquid ejection apparatus 1 is not limited to the line-type ink jet printer, and may be a serial-type ink jet printer. Further, the liquid ejection apparatus 1 is not limited to the ink jet printer, and may be a coloring material ejection apparatus used for manufacturing a color filter for a liquid crystal display or the like, an electrode material ejection apparatus used for forming an electrode for an organic EL display, a field emission display (FED), or the like, a bioorganic substance ejection apparatus used for manufacturing a biochip, and the like, and may be a three-dimensional shaping apparatus, a textile printing apparatus, or the like. Here, in the following description, a direction in which the medium P is transported may be referred to as a transport direction, and a width direction of the transported medium P may be referred to as a main scanning direction.

As shown in FIG. 1, the liquid ejection apparatus 1 includes a control unit 2, a liquid container 3, a transport unit 4, a plurality of ejection units 5, and a power supply unit 6.

The power supply unit 6 generates, for example, a power supply voltage signal VDC which is a signal of a constant DC voltage having a voltage value of 48 V from a signal of an AC voltage of a commercial power supply which is supplied to the liquid ejection apparatus 1, and outputs the power supply voltage signal VDC to each portion of the liquid ejection apparatus 1. Such a power supply unit 6 includes an AC/DC converter such as a flyback circuit. In addition to the power supply voltage signal VDC, the power supply unit 6 may generate a signal of one or a plurality of DC voltages with different voltage values used as the power supply voltage in the control unit 2, the liquid container 3, the transport unit 4, and the like, and output the signal to a corresponding configuration. In this case, the power supply unit 6 may include a DC/DC converter in addition to the AC/DC converter described above.

The control unit 2 includes a processing circuit such as a central processing unit (CPU) and a field programmable gate array (FPGA), and a storage circuit such as a semiconductor memory. The control unit 2 generates various signals including a transport control signal Ctrl-T and an image information signal IP, which are signals for controlling each element of the liquid ejection apparatus 1, based on image data supplied from an external device such as a host computer (not illustrated) provided outside the liquid ejection apparatus 1, and outputs the generated signals to corresponding configurations.

The ink as an example of the liquid supplied to the ejection units 5 is stored in the liquid container 3. Specifically, the liquid container 3 stores a plurality of colors of ink to be ejected to the medium P such as black, cyan, magenta, yellow, red, and gray. As the liquid container 3, an ink cartridge, a bag-shaped ink pack made of a flexible film, an ink tank that is refilled with ink, and the like can be used.

The transport unit 4 includes a transport motor 41 and a transport roller 42. The transport control signal Ctrl-T output by the control unit 2 is input to the transport unit 4. The transport motor 41 is driven based on the transport control signal Ctrl-T, and the transport roller 42 rotates as the transport motor 41 is driven. In accordance with rotation of the transport roller 42, the medium P is transported along the transport direction. That is, the liquid ejection apparatus 1 includes the transport unit 4 that transports the medium P.

Each of the plurality of ejection units 5 includes a drive module 10 and an ejection module 20. The power supply voltage signal VDC output by the power supply unit 6 and a corresponding image information signal IP output by the control unit 2 are input to each of the plurality of ejection units 5, and the ink stored in the liquid container 3 is supplied via an ink tube (not illustrated). The drive module 10 operates by using the power supply voltage signal VDC as drive power, and controls an operation of the ejection module 20 based on the image information signal IP. As a result, the ejection module 20 ejects the ink supplied from the liquid container 3 at a predetermined timing corresponding to the control of the drive module 10.

In the liquid ejection apparatus 1 of the present embodiment, the ejection modules 20 included in each of the plurality of ejection units 5 are located side by side to be equal to or larger than a width of the medium P along the main scanning direction. According to this, a line head is configured. Each of the plurality of ejection units 5 ejects ink to the medium P at a timing synchronized with the transport of the medium P. As a result, the ink lands on a desired position of the medium P, and the desired image is formed on the medium P.

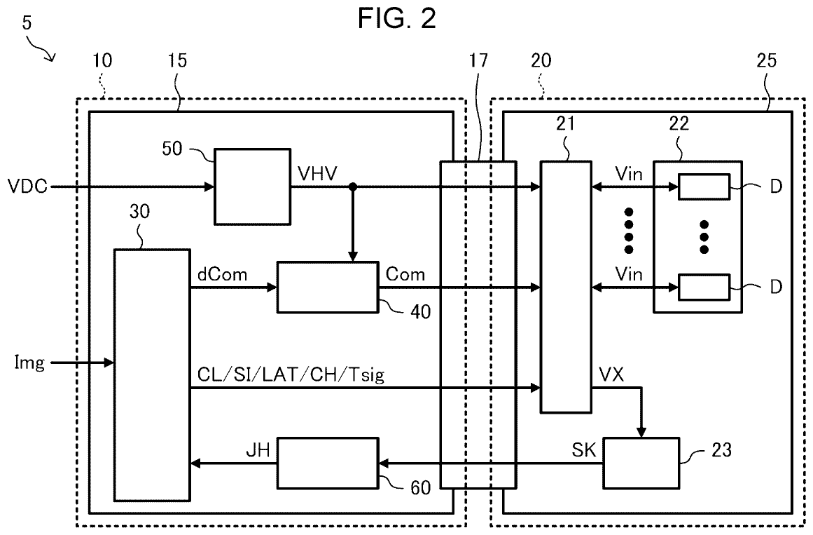

Here, a specific example of a configuration of the ejection unit 5 will be described. FIG. 2 is a view illustrating an example of a functional configuration of the ejection unit 5.

As described above, the power supply voltage signal VDC and the image information signal IP are input to the ejection unit 5. The ejection unit 5 forms an image corresponding to the image information signal IP on the medium P by driving the power supply voltage signal VDC as drive power.

As shown in FIG. 2, the ejection unit 5 includes the drive module 10 and the ejection module 20. In addition, the drive module 10 includes a control circuit 30, a drive circuit 40, a power supply circuit 50, and a determination circuit 60, and the control circuit 30, the drive circuit 40, the power supply circuit 50, and the determination circuit 60 are provided on a wiring substrate 15, and the ejection module 20 includes a print head 25. The wiring substrate 15 included in the drive module 10 and the print head 25 included in the ejection module 20 are electrically coupled to each other via a coupling member 17 which is a BtoB connector. As a result, the wiring substrate 15 included in the drive module 10 and the print head 25 included in the ejection module 20 are communicably connected. In other words, the print head 25 and the wiring substrate 15 are electrically coupled to each other via the coupling member 17 which is a BtoB connector. Here, the coupling member 17 is not limited to the BtoB connector, and may be a flexible flat cable or a flexible wiring substrate, and various connectors including the BtoB connector and the flexible flat cable or the flexible wiring substrate may be used in combination.

In the present embodiment, a case where the ejection module 20 includes one print head 25 will be described as an example, but the ejection module 20 may include a plurality of the print heads 25.

The power supply voltage signal VDC is input to the power supply circuit 50. The power supply circuit 50 generates and outputs a power supply voltage signal VHV that is a signal of a DC voltage used as a power supply voltage of each portion of the liquid ejection apparatus 1, for example, a signal of a constant DC voltage having a voltage value of 42 V by stepping down a voltage value of the power supply voltage signal VDC. Such a power supply circuit 50 is a DC/DC converter that steps down the power supply voltage signal VDC that is a signal of a DC voltage and outputs the power supply voltage signal VHV that is a signal of a DC voltage, and is constituted by a DC/DC converter including a switching power supply circuit. Details of the configuration of the power supply circuit 50 will be described later.

Here, the power supply circuit 50 may be configured to output signals of a plurality of DC voltages having a voltage value different from that of the power supply voltage signal VHV, for example, a signal of a DC voltage having a voltage value of 5 V or a signal of a DC voltage having a voltage value of 3.3 V in addition to the power supply voltage signal VHV. In this case, the power supply circuit 50 may include one or a plurality of DC/DC converters that step down the voltage value of the power supply voltage signal VHV. Further, the power supply circuit 50 may be configured to receive a signal of an AC voltage of a commercial power supply or the like instead of the power supply voltage signal VDC. That is, the power supply circuit 50 may include an AC/DC converter as the switching power supply circuit, the AC/DC converter may receive a signal of an AC voltage of a commercial power supply or the like, and may output a power supply voltage signal VHV which is a signal of a DC voltage.

The control circuit 30 controls an operation of each configuration of the liquid ejection apparatus 1 including the drive circuit 40, the determination circuit 60, and the print head 25. The control circuit 30 includes one or more central processing units (CPU). The control circuit 30 may include a programmable logic device such as a field programmable gate array (FPGA) instead of the CPU or in addition to the CPU, and may further include a storage circuit. The control circuit 30 generates and outputs a signal for controlling the operation of each portion of the ejection unit 5 such as a clock signal CL, a print data signal SI, a latch signal LAT, a change signal CH, a period designation signal Tsig, and a drive waveform designation signal dCom in correspondence with the input image information signal IP. The control circuit 30 may further output a signal for controlling an output of the power supply voltage signal VHV from the power supply circuit 50.

The drive waveform designation signal dCom output by the control circuit 30 is input to the drive circuit 40. In addition, the power supply voltage signal VHV output by the power supply circuit 50 is also input to the drive circuit 40. The drive circuit 40 generates and outputs a drive signal Com for driving a plurality of ejection portions D described later included in the print head 25. Specifically, the drive waveform designation signal dCom is a digital signal that designates a signal waveform of the drive signal Com output by the drive circuit 40, and the drive circuit 40 converts the input drive waveform designation signal dCom into an analog signal by a DA conversion circuit (not illustrated), and generates and outputs the drive signal Com in which the signal waveform designated by the drive waveform designation signal dCom is amplified by class D amplification of the converted analog signal in correspondence with the power supply voltage signal VHV. The drive circuit 40 may generate and output the drive signal Com by performing class B amplification or class AB amplification on the signal waveform defined by the drive waveform designation signal dCom in correspondence with the power supply voltage signal VHV.

The clock signal CL, the print data signal SI, the latch signal LAT, the change signal CH, and the period designation signal Tsig output by the control circuit 30, the drive signal Com output by the drive circuit 40, and the power supply voltage signal VHV output by the power supply circuit 50 are input to the print head 25. The print data signal SI is a signal that propagates in synchronization with the clock signal CL, and is a digital signal that designates a type of an operation of the plurality of ejection portions D in each of the periods defined by the latch signal LAT, the change signal CH, and the period designation signal Tsig. Specifically, the print data signal SI is a signal including information for designating whether or not to supply the drive signal Com to each of the plurality of ejection portions D in each of periods defined by the latch signal LAT, the change signal CH, and the period designation signal Tsig, and accordingly, the operation of a corresponding ejection portion D is individually designated.

The print head 25 includes a supply switching circuit 21, a recording head 22, and a detection circuit 23. Further, the recording head 22 includes the plurality of ejection portions D. Here, in the following description, it is assumed that the recording head 22 includes M ejection portions D. When the M ejection portions D included in the recording head 22 are individually designated and described, the M ejection portions D are referred to as ejection portions D[1] to D[M]. At this time, when the m-th ejection portion D among the M ejection portions D included in the recording head 22 is designated and described, the m-th ejection portion D may be referred to as an ejection portion D[m]. Here, M is a natural number satisfying “M≥1”, and m is any natural number satisfying “1≤m≤M”. Further, in the following description, when indicating that a component, a signal, or the like of the liquid ejection apparatus 1 corresponds to the ejection portion D[m] among the M ejection portions D, a subscript [m] may be added to a reference numeral indicating the component, the signal, or the like. That is, the print head 25 includes the plurality of ejection portions D and the supply switching circuit 21.

The clock signal CL, the print data signal SI, the latch signal LAT, the change signal CH, the period designation signal Tsig, the drive signal Com, and the power supply voltage signal VHV are input to the supply switching circuit 21 included in the print head 25. The supply switching circuit 21 switches whether or not to supply the drive signal Com as a supply drive signal Vin to a corresponding ejection portion D based on the print data signal SI at each timing defined by the latch signal LAT, the change signal CH, and the period designation signal Tsig. When the supply drive signal Vin is supplied to a piezoelectric element PZ (to be described later) included in the ejection portion D, the piezoelectric element PZ is driven, and ink in an amount corresponding to a drive amount of the piezoelectric element PZ is ejected from the ejection portion D.

In addition, the supply switching circuit 21 switches whether or not to acquire a signal corresponding to a residual vibration generated in an ejection portion D that is an inspection target based on the print data signal SI and supply the signal to the detection circuit 23 as a detection potential signal VX at each timing defined by the latch signal LAT, the change signal CH, and the period designation signal Tsig.

The detection circuit 23 generates a detection signal SK based on the detection potential signal VX supplied via the supply switching circuit 21, and outputs the detection signal SK from the print head 25. Specifically, the detection circuit 23 amplifies the input detection potential signal VX, removes a noise component, converts the signal into a digital signal to generate the detection signal SK, and outputs the detection signal SK from the print head 25.

The detection signal SK output from the print head 25 is input to the determination circuit 60. The determination circuit 60 determines whether or not an ink ejection state of the ejection portion D that is an inspection target is normal based on the input detection signal SK, that is, whether or not the ejection portion D that is an inspection target is in a normal ejection state. Specifically, the determination circuit 60 reads predetermined determination threshold information and correction value information from a storage circuit (not illustrated) including a non-volatile memory such as a read only memory (ROM) and a flash memory. The determination circuit 60 corrects the input detection signal SK in correspondence with the correction value information that is read, and compares the corrected signal with predetermined determination threshold information. The determination circuit 60 determines whether or not ejection abnormality occurs in the ejection portion D that is an inspection target in correspondence with the comparison result, that is, whether or not the ejection portion D that is an inspection target is in a normal ejection state. The determination circuit 60 generates a determination result indicating a state determination signal JH and outputs the state determination signal JH to the control circuit 30. Here, in the following description, the determination as to whether or not ejection abnormality occurs in the ejection portion D that is an inspection target, that is, the determination as to whether or not the ejection portion D that is an inspection target is in the normal ejection state may be simply referred to as a determination of a state of the ejection portion D that is an inspection target.

Here, the ejection abnormality is a general term for a state in which an abnormality occurs in an ink ejection state from the ejection portion D that is an inspection target, and a state in which the ink cannot be accurately ejected from the ejection portion D that is an inspection target. Such an ejection abnormality includes, for example, a state in which ink cannot be ejected from the ejection portion D, a state in which an ink amount different from an ink ejection amount defined by the drive signal Com is ejected from the ejection portion D, a state in which the ink is ejected from the ejection portion D at a speed different from an ink ejection speed defined by the drive signal Com, and the like.

As described above, when an ejection process of ejecting ink to form an image corresponding to the image information signal IP on the medium P is executed, the control circuit 30 generates a signal such as the print data signal SI for controlling the print head 25 to eject ink based on the image information signal IP and outputs the signal to the print head 25, and generates the drive waveform designation signal dCom for controlling the drive circuit 40 to output the drive signal Com for driving the ejection portion D to eject the ink and outputs the drive waveform designation signal dCom to the drive circuit 40, and the drive circuit 40 generates the drive signal Com corresponding to the input drive waveform designation signal dCom and outputs the drive signal Com to the print head 25. As a result, presence or absence of ink ejection from each of the plurality of ejection portions D, the ink ejection amount, the ink ejection timing, and the like are controlled. As a result, an image corresponding to the image information signal IP is formed on the medium P.

In addition, when a determination process of determining a state of the ejection portion D is executed, the control circuit 30 generates a signal such as the print data signal SI for determining the state of the ejection portion D that is an inspection target and outputs the signal to the print head 25, and generates the drive waveform designation signal dCom for controlling the drive circuit 40 to output the drive signal Com for determining the state of the ejection portion D and outputs the drive waveform designation signal dCom to the drive circuit 40, and the drive circuit 40 generates the drive signal Com corresponding to the input drive waveform designation signal dCom and outputs the drive signal Com to the print head 25. As a result, the supply switching circuit 21 outputs a signal corresponding to a residual vibration generated in the ejection portion D that is an inspection target to the detection circuit 23 as the detection potential signal VX, and the detection circuit 23 acquires the input detection potential signal VX, generates the detection signal SK corresponding to the acquired detection potential signal VX, and outputs the detection signal SK to the determination circuit 60. Then, the determination circuit 60 determines whether or not the ink ejection state of the ejection portion D that is an inspection target is normal based on the input detection signal SK, that is, whether or not the ejection portion D that is an inspection target is in a normal ejection state, and outputs the state determination signal JH corresponding to the determination result to the control circuit 30. As a result, the control circuit 30 can acquire the state of the ejection portion D that is an inspection target and correct various signals to be output in correspondence with the acquired state of the ejection portion D that is an inspection target. As a result, the quality of the image formed on the medium is improved.

As described above, in the liquid ejection apparatus 1 of the present embodiment, the ejection unit 5 executes various processes including the ejection process of forming an image corresponding to the image information signal IP on the medium and the determination process of determining the state of the ejection portion D that ejects the ink to the medium.

In the liquid ejection apparatus 1, the control circuit 30 and the determination circuit 60 included in the drive module 10 of the ejection unit 5 may be mounted on a common semiconductor device. At this time, a part or all of the drive circuit 40 and the transport unit 4 may be mounted on the semiconductor device. In addition, the supply switching circuit 21 and the detection circuit 23 included in the print head 25 of the ejection module 20 may be mounted on a common semiconductor device.

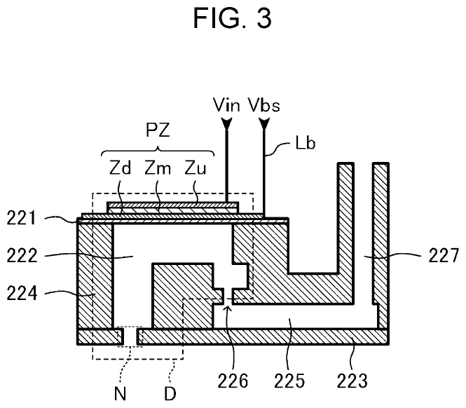

Here, an example of a structure of the ejection portion D that ejects the ink to the medium P will be described. FIG. 3 is a view illustrating a schematic structure of one ejection portion D. As shown in FIG. 3, the ejection portion D includes a piezoelectric element PZ, a cavity 222 filled with ink, a nozzle N communicating with the cavity 222, and a vibration plate 221. Then, in the ejection portion D, the piezoelectric element PZ is driven by supply of the supply drive signal Vin to the piezoelectric element PZ, and the ink stored inside the cavity 222 is ejected from the nozzle N by the driving of the piezoelectric element PZ.

The cavity 222 is a space partitioned by a cavity plate 224, a nozzle plate 223 in which the nozzle N is formed, and the vibration plate 221. The cavity 222 communicates with a reservoir 225 via an ink supply port 226, and the reservoir 225 communicates with the liquid container 3 corresponding to the ejection portion D via an ink intake port 227. As a result, the ink is supplied from a corresponding liquid container 3 to the inside of the cavity 222 via the ink intake port 227, the reservoir 225, and the ink supply port 226. Therefore, the ink supplied from the corresponding liquid container 3 is filled in the cavity 222.

The piezoelectric element PZ includes an upper electrode Zu, a lower electrode Zd, and a piezoelectric substance Zm. The piezoelectric substance Zm is positioned between the upper electrode Zu and the lower electrode Zd. The supply drive signal Vin output by the supply switching circuit 21 is supplied to the upper electrode Zu. In addition, a reference voltage signal Vbs propagating through a wiring Lb is supplied to the lower electrode Zd. The piezoelectric substance Zm is displaced in an up and down direction of FIG. 3 in correspondence with a potential difference between the upper electrode Zu and the lower electrode Zd, that is, a potential difference between a voltage value of the supply drive signal Vin supplied to the upper electrode Zu and a voltage value of the reference voltage signal Vbs supplied to the lower electrode Zd. That is, the piezoelectric element PZ is driven in correspondence with the potential difference between the voltage value of the supply drive signal Vin and the voltage value of the reference voltage signal Vbs. Here, the reference voltage signal Vbs supplied to the lower electrode Zd is a signal that becomes a reference potential of the driving of the piezoelectric element PZ, has a constant potential of 5.5 V or 6 V and is constant in a ground potential, or the like.

The lower electrode Zd is bonded to the vibration plate 221. Therefore, when the piezoelectric element PZ is driven to be displaced in the up and down direction shown in FIG. 3 by the supply drive signal Vin, the vibration plate 221 is also displaced in the up and down direction shown in FIG. 3. An internal volume and an internal pressure of the cavity 222 change due to the displacement of the vibration plate 221. Then, the ink filled in the cavity 222 is ejected from the nozzle N in correspondence with the change in the internal volume and the internal pressure of the cavity 222. That is, the ink in an amount corresponding to the drive amount of the piezoelectric element PZ is ejected from the nozzle N of the ejection portion D. In other words, the piezoelectric element PZ ejects the ink in an amount corresponding to the displacement caused by supply of the supply drive signal Vin corresponding to the drive signal Com from the ejection portion D. In other words, the print head 25 included in the liquid ejection apparatus 1 of the present embodiment includes the ejection portion D that ejects the liquid by driving of the piezoelectric element PZ.

### 2. Configuration and Operation of Print Head

### 2.1 Configuration of Print Head

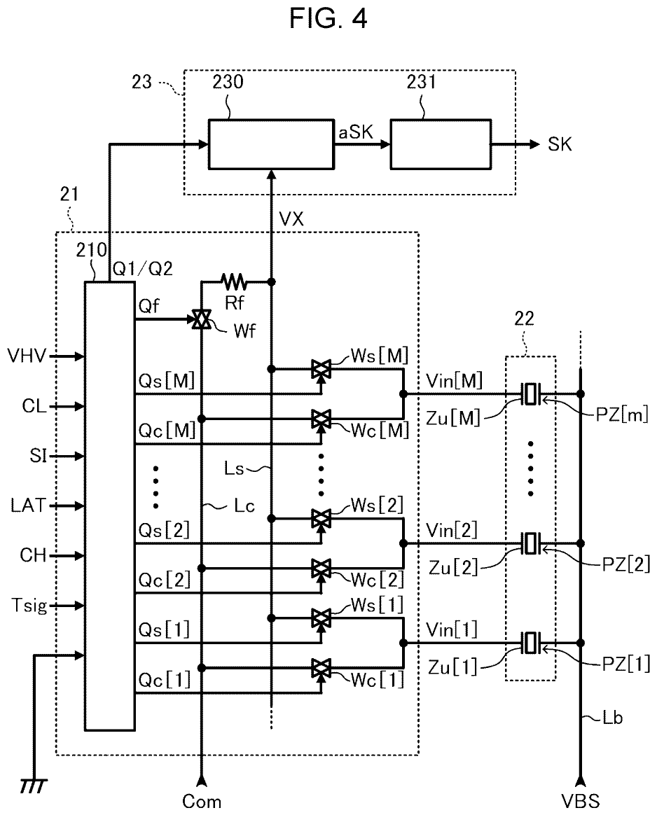

Next, a functional configuration of the print head 25 will be described. FIG. 4 is a view illustrating an example of the functional configuration of the print head 25. As described above, the print head 25 includes the supply switching circuit 21, the recording head 22, and the detection circuit 23. In addition, in FIG. 4, in the print head 25, a wiring Lc through which the drive signal Com propagates, the wiring Lb through which the reference voltage signal Vbs propagates, and a wiring Ls through which the detection potential signal VX propagates to the detection circuit 23 are shown.

The supply switching circuit 21 includes switches Wc[1] to Wc[M], switches Ws[1] to Ws[M], a switch Wf, a resistor Rf, and a coupling state designation circuit 210. The switches Wc[1] to Wc[M] and the switches Ws[1] to Ws[M] are provided in correspondence with the ejection portions D[1] to D[M] in the supply switching circuit 21. Specifically, in the supply switching circuit 21, the switch Wc[m] and the switch Ws[m] are provided in correspondence with the ejection portion D[m].

The print head 25 receives the power supply voltage signal VHV, the clock signal CL, the print data signal SI, the latch signal LAT, the change signal CH, and the period designation signal Tsig. The power supply voltage signal VHV, the clock signal CL, the print data signal SI, the latch signal LAT, the change signal CH, and the period designation signal Tsig are input to the coupling state designation circuit 210.

The coupling state designation circuit 210 generates a signal for designating a conduction state of each of the switches Wc[1] to Wc[M], the switches Ws[1] to Ws[M], and the switch Wf in correspondence with the print data signal SI propagated in synchronization with the clock signal CL in each of periods defined by the input latch signal LAT, the change signal CH, and the period designation signal Tsig. Thereafter, the coupling state designation circuit 210 outputs the signals for designating the conduction states of the switches Wc[1] to Wc[M] as coupling state designation signals Qc[1] to Qc[M] by level-shifting the signals for designating the conduction states of the switches Wc[1] to Wc[M] to high-amplitude logic signals with a voltage value of the power supply voltage signal VHV, outputs the signals for designating the conduction states of the switches Ws[1] to Ws[M] as coupling state designation signals Qs[1] to Qs[M] by level-shifting the signals for designating the conduction states of the switches Ws[1] to Ws[M] to high-amplitude logic signal with a voltage value of the power supply voltage signal VHV, and outputs the signal for designating the conduction state of the switch Wf as a coupling state designation signal Qf by level-shifting the signal for designating the conduction state of the switch Wf to a high-amplitude logic signal with a voltage value of the power supply voltage signal VHV. That is, the coupling state designation circuit 210 generates and outputs the coupling state designation signals Qc[1] to Qc[M], Qs[1] to Qs[M], and Qf in which a H level is the power supply voltage signal VHV and a L level is the ground potential.

The coupling state designation signals Qc[1] to Qc[M] output by the coupling state designation circuit 210 are input to control terminals of the switches Wc[1] to Wc[M], the coupling state designation signals Qs[1] to Qs[M] output by the coupling state designation circuit 210 are input to control terminals of the switches Ws[1] to Ws[M], and the coupling state designation signal Qf output by the coupling state designation circuit 210 is input to a control terminal of the switch Wf. As a result, the conduction state of each of the switches Wc[1] to Wc[M], Ws[1] to Ws[M], and Wf is controlled.

The coupling state designation circuit 210 includes, for example, a register that holds the print data signal SI propagated in synchronization with the clock signal CL in correspondence with the ejection portions D[1] to D[M], a decoder that decodes the print data signal SI held in the register to generate a signal for designating conduction states of the switches Wc[1] to Wc[M], Ws[1] to Ws[M], and Wf, and a level shift circuit that outputs the coupling state designation signals Qc[1] to Qc[M], Qs[1] to Qs[M], Qf, and the like which are obtained by level-shifting the logic of a signal generated by the decoder into a high-amplitude logic signal with a voltage value of the power supply voltage signal VHV.

In the switch Wc[m] among the switch Wc[1] to Wc[M], one end is electrically coupled to the wiring Lc, and the other end is electrically coupled to the upper electrode Zu[m] of the piezoelectric element PZ[m] included in the ejection portion D[m]. The coupling state designation signal Qc[m] among the coupling state designation signals Qc[1] to Qc[M] is input to a control terminal of the switch Wc[m]. In the switch Wc[m], a conduction state between the one end and the other end is switched in correspondence with a logic level of the coupling state designation signal Qc[m] input to the control terminal. That is, the switch Wc[m] switches a coupling state between the wiring Lc and the upper electrode Zu[m] in correspondence with the logic level of the coupling state designation signal Qc[m] input to the control terminal. As a result, the switch Wc[m] switches whether or not to supply the drive signal Com propagating through the wiring Lc to the upper electrode Zu[m] of the ejection portion D[m] as the supply drive signal Vin[m] in correspondence with the coupling state designation signal Qc[m].

In the switch Ws[m] among the switches Ws[1] to Ws[M], one end is electrically coupled to the wiring Ls, and the other end is electrically coupled to the upper electrode Zu[m] of the piezoelectric element PZ[m] included in the ejection portion D[m]. The coupling state designation signal Qs[m] among the coupling state designation signals Qs[1] to Qs[M] is input to a control terminal of the switch Ws[m]. The switch Ws[m] switches the conduction state between one end and the other end in correspondence with a logic level of the coupling state designation signal Qs[m] input to a control terminal. That is, the switch Ws[m] switches the coupling state between the wiring Ls and the upper electrode Zu[m] in correspondence with the logic level of the coupling state designation signal Qs[m] input to the control terminal. As a result, the switch Ws[m] switches whether or not to supply a signal generated in the upper electrode Zu[m] of the piezoelectric element PZ[m] to the wiring Ls in correspondence with the coupling state designation signal Qs[m] and a residual vibration generated in the ejection portion D[m].

In the switch Wf, one end is electrically coupled to the wiring Lc, and the other end is electrically coupled to one end of the resistor Rf. In addition, the other end of the resistor Rf is electrically coupled to the wiring Ls. That is, in the switch Wf, the one end is electrically coupled to the wiring Lc, and the other end is electrically coupled to the wiring Ls via the resistor Rf. The coupling state designation signal Qf is input to the control terminal of the switch Wf. The switch Wf switches the conduction state between the one end and the other end in correspondence with a logic level of the coupling state designation signal Qf input to the control terminal. That is, the switch Wf switches the coupling state between the wiring Lc and the wiring Ls in correspondence with the logic level of the coupling state designation signal Qf input to the control terminal.

That is, the supply switching circuit 21 includes the switches Ws[1] to Ws[M] that switch whether or not to supply the detection potential signal VX to the detection circuit 23, and the switches Wc[1] to Wc[M] that switch whether or not to supply the drive signal Com to the ejection portions D[1] to D[M]. The switches Ws[1] to Ws[M] switch whether or not to supply the detection potential signal VX to the detection circuit 23 based on the coupling state designation signals Qs[1] to Qs[M] corresponding to the power supply voltage signal VHV, and the switches Wc[1] to Wc[M] switch whether or not to supply the drive signal Com to the piezoelectric elements PZ[1] to PZ[M] based on the coupling state designation signals Qc[1] to Qc[M] corresponding to the power supply voltage signal VHV. That is, the power supply voltage signal VHV output by the power supply circuit 50 is supplied to the switches Wc[1] to Wc[M] and Ws[1] to Ws[M].

Each of the switches Wc[1] to Wc[M] and Ws[1] to Ws[M] can be constituted by, for example, a transmission gate. Here, an example of the configuration of the transmission gates constituting the switches Wc[1] to Wc[M] and Ws[1] to Ws[M] will be described. The switches Wc[1] to Wc[M] and Ws[1] to Ws[M] have the same configuration except that input signals and output signals are different. Therefore, in the following description, the switches Wc[1] to Wc[M] and Ws[1] to Ws[M] will be simply referred to as a switch W without distinction. At this time, description will be made on the assumption that one end of the switch W is electrically coupled to the wiring Lc through which the drive signal Com propagates or a wiring L as the wiring Ls through which the detection potential signal VX propagates to the detection circuit 23, the other end of the switch W is electrically coupled to the upper electrode Zu of the piezoelectric element PZ included in the ejection portion D as the ejection portions D[1] to D[M], and a coupling state designation signal Q as the coupling state designation signals Qc[1] to Qc[M] and Qs[1] to Qs[M] is input to a control terminal of the switch W.

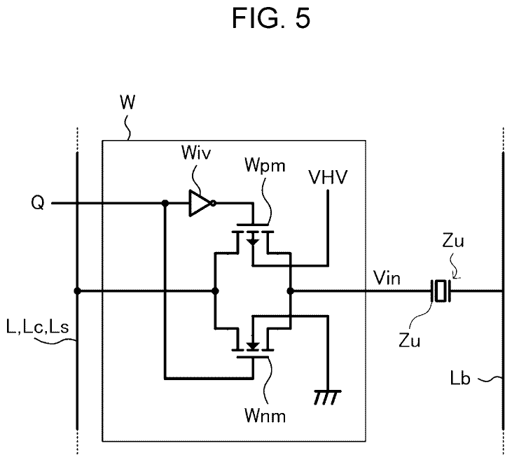

FIG. 5 is a view illustrating an example of a configuration of the switch W. As shown in FIG. 5, the switch W includes a transistor Wnm that is an n-channel type MOS-FET, a transistor Wpm that is a p-channel type MOS-FET, and an inverter Wiv.

One end of the transistor Wnm and one end of the transistor Wpm are electrically coupled to each other, and the other end of the transistor Wnm and the other end of the transistor Wpm are electrically coupled to each other. Here, the one end of the transistor Wnm corresponds to a drain terminal of the switches Wc[1] to Wc[M] and corresponds to a source terminal of the switches Ws[1] to Ws[M], the other end of the transistor Wnm corresponds to a source terminal of the switches Wc[1] to Wc[M] and corresponds to a drain terminal of the switches Ws[1] to Ws[M], the one end of the transistor Wpm corresponds to a source terminal of the switches Wc[1] to Wc[M] and corresponds to a drain terminal of the switches Ws[1] to Ws[M], and the other end of the transistor Wpm corresponds to a drain terminal of the switches Wc[1] to Wc[M] and corresponds to a source terminal of the switches Ws[1] to Ws[M].

A coupling point where the one end of the transistor Wnm and the one end of the transistor Wpm are coupled is electrically coupled to the wiring L, and a coupling point where the other end of the transistor Wnm and the other end of the transistor Wpm are coupled to each other is electrically coupled to the upper electrode Zu of the piezoelectric element PZ. That is, the coupling point where the one end of the transistor Wnm and the one end of the transistor Wpm are coupled to each other corresponds to one end of the switch W, and the coupling point where the other end of the transistor Wnm and the other end of the transistor Wpm are coupled to each other corresponds to the other end of the switch W.

The coupling state designation signal Q is input to a gate terminal of the transistor Wnm, and a signal in which a logic level of the coupling state designation signal Q is inverted is input to the gate terminal of the transistor Wpm via the inverter Wiv. That is, conduction states of the transistor Wnm and the transistor Wpm are controlled by the coupling state designation signal Q based on the power supply voltage signal VHV.

In addition, the ground potential is supplied to a back gate terminal of the transistor Wnm, and the power supply voltage signal VHV is supplied to a back gate terminal of the transistor Wpm.

In the switch W configured as described above, when the coupling state designation signal Q of an H level is input, conduction between one end and the other end of the transistor Wnm and between one end and the other end of the transistor Wpm is controlled, and when the coupling state designation signal Q of an L level is input, non-conduction between one end and the other end of the transistor Wnm and between one end and the other end of the transistor Wpm is controlled. That is, the switch W is controlled to be conductive between one end and the other end when the coupling state designation signal Q of an H level is input to the control terminal of the switch W, and is controlled to be non-conductive between one end and the other end when the coupling state designation signal Q of an L level is input to the control terminal of the switch W.

The switch W may be configured to receive the coupling state designation signal Q at the gate terminal of the transistor Wpm and receive a signal in which the logic level of the coupling state designation signal Q is inverted at the gate terminal of the transistor Wnm via the inverter Wiv. In this case, the switch W may be controlled to be conductive between one end and the other end when the coupling state designation signal Q of an L level is input to the control terminal of the switch W, and may be controlled to be non-conductive between one end and the other end when the coupling state designation signal Q of an H level is input to the control terminal of the switch W.

That is, the switches Wc[1] to Wc[M] include the transistors Wnm and Wpm that switch whether or not to supply the drive signal Com to the piezoelectric elements PZ[1] to PZ[M], the power supply voltage signal VHV is supplied to the back gate terminal of the transistor Wpm, the switches Ws[1] to Ws[M] include the transistors Wnm and Wpm that switch whether or not to supply the detection potential signal VX to the detection circuit 23, and the power supply voltage signal VHV is supplied to the back gate terminal of the transistor Wpm.

Returning to FIG. 4, the coupling state designation circuit 210 generates coupling state designation signals Q1 and Q2 in a period defined by the input latch signal LAT, the change signal CH, and the period designation signal Tsig in correspondence with the print data signal SI propagated based on the clock signal CL, and outputs the coupling state designation signals Q1 and Q2 to the detection circuit 23.

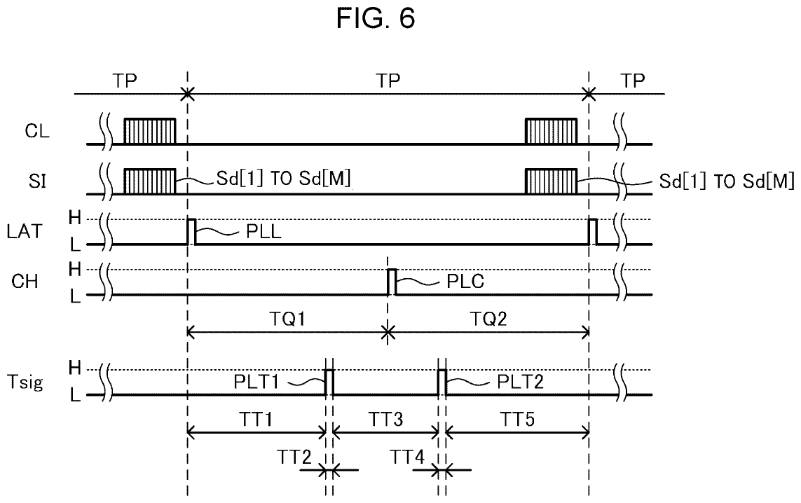

Here, an example of various signals input to the coupling state designation circuit 210 will be described. FIG. 6 is a view illustrating an example of various signals input to the coupling state designation circuit 210. As shown in FIG. 6, the liquid ejection apparatus 1 of the present embodiment defines one or a plurality of unit periods TP as an operation period, and controls the driving of the ejection portion D[m] and the operation of the detection circuit 23 in each of the defined unit periods TP.

Specifically, the control circuit 30 generates the latch signal LAT including a pulse PLL and outputs the latch signal LAT to the coupling state designation circuit 210. For example, the control circuit 30 may generate the latch signal LAT including the pulse PLL and output the latch signal LAT to the coupling state designation circuit 210 by setting the logic level of the latch signal LAT to the H level for a short time at a timing based on a transport position of the medium P transported along the transport direction. Further, for example, the control circuit 30 may generate the latch signal LAT including the pulse PLL by setting the logic level of the latch signal LAT to the H level for a short time at a predetermined time interval, and output the latch signal LAT to the coupling state designation circuit 210. A period from the rise of the pulse PLL included in the latch signal LAT to the subsequent rise of the pulse PLL corresponds to the above-described unit period TP.

Further, the control circuit 30 generates the change signal CH including a pulse PLC and outputs the change signal CH to the coupling state designation circuit 210. For example, the control circuit 30 generates the change signal CH including the pulse PLC by setting the logic level of the change signal CH to the H level for a short time at a timing when a predetermined time elapses from the rise of the pulse PLL, and outputs the change signal CH to the coupling state designation circuit 210. The pulse PLC included in the change signal CH divides the unit period TP into a control period TQ1 and a control period TQ2. Specifically, the change signal CH divides the unit period TP into the control period TQ1 from the rise of the pulse PLC to the rise of the pulse PLL, and the control period TQ2 from the rise of the pulse PLL to the rise of the pulse PLC. The number of the periods divided from the unit period TP by the change signal CH is not limited to two.

The control circuit 30 generates the period designation signal Tsig including pulses PLT1 and PLT2, and outputs the period designation signal Tsig to the coupling state designation circuit 210. For example, the control circuit 30 generates the pulse PLT1 by setting the logic level of the period designation signal Tsig to the H level at a timing when a predetermined time elapses from the rise of the pulse PLL, and then setting the logic level of the period designation signal Tsig to the L level, and outputs the pulse PLT1 to the coupling state designation circuit 210. After generating the pulse PLT1, the control circuit 30 generates the pulse PLT2 by setting the logic level of the period designation signal Tsig to the H level at a timing when a predetermined time elapses, and then setting the logic level of the period designation signal Tsig to the L level, and outputs the pulse PLT2 to the coupling state designation circuit 210. The pulses PLT1 and PLT2 included in the period designation signal Tsig divide the unit period TP into the control periods TT1 to TT5. Specifically, the period designation signal Tsig divides the unit period TP into a control period TT1 that is a period from the rise of the pulse PLL to the rise of the pulse PLT1, a control period TT2 that is a period from the rise of the pulse PLT1 to the fall of the pulse PLT1, a control period TT3 that is a period from the fall of the pulse PLT1 to the rise of the pulse PLT2, a control period TT4 that is a period from the rise of the pulse PLT2 to the fall of the pulse PLT2, and a control period TT5 that is a period from the fall of the pulse PLT2 to the rise of the pulse PLL. The number of periods divided from the unit period TP by the period designation signal Tsig is not limited to five.

Further, the control circuit 30 generates the print data signal SI serially including the individual designation signals Sd[1] to Sd[M] and outputs the print data signal SI to the coupling state designation circuit 210. Each of the individual designation signals Sd[1] to Sd[M] is a signal including 3-bit information, and defines a drive mode of each of the ejection portions D[1] to D[M]. Here, in the following description, the 3-bit information included in the individual designation signal Sd[m] may be referred to as bits S1, S2, and S3, and the individual designation signal Sd[m] may be expressed as Sd[m]=[S1, S2, S3]. Further, in the following description, a case where the bits S1, S2, and S3 included in the individual designation signal Sd[m] may be any of “1” and “0 ” may be expressed by using “*”.

Specifically, the control circuit 30 generates the print data signal SI including the individual designation signals Sd[1] to Sd[M] that define a drive mode of the driving of the ejection portions D[1] to D[M] in the unit period TP that is a control target and an operation of the detection circuit 23 before the unit period TP that is a control target, and outputs the print data signal SI to the coupling state designation circuit 210. In the coupling state designation circuit 210, the print data signal SI is held in a register (not illustrated) in a state in which each of the individual designation signals Sd[1] to Sd[M] corresponds to each of the ejection portions D[1] to D[M]. Then, in the unit period TP that is a control target, the coupling state designation circuit 210 simultaneously latches the 3-bit information included in each of the held individual designation signals Sd[1] to Sd[M], and decodes the latched 3-bit information. Accordingly, the coupling state designation circuit 210 generates the coupling state designation signals Qc[1] to Qc[M], Qs[1] to Qs[M], Qf, Q1, and Q2 of the logic level corresponding to a decoding content in each of the control periods TQ1 and TQ2 in the unit period TP that is a control target, or in each of the control periods TT1 to TT5, and outputs the generated signals to the control terminals of the corresponding switches Wc[1] to Wc[M], Ws[1] to Ws[M], Wf, W1, and W2.

As a result, the conduction state of each of the switches Wc[1] to Wc[M], Ws[1] to Ws[M], Wf, W1, and W2 in each of the control periods TQ1 and TQ2 or each of the control periods TT1 to TT5 is controlled. As a result, the drive mode of the ejection portions D[1] to D[M] or the operation of the detection circuit 23 is controlled in each of the control periods TQ1 and TQ2 or each of the control periods TT1 to TT5.

Returning to FIG. 4, the detection potential signal VX propagating through the wiring Ls and the coupling state designation signals Q1 and Q2 output by the coupling state designation circuit 210 are input to the detection circuit 23. In addition, the detection circuit 23 includes a waveform shaping circuit 230 and an AD conversion circuit 231. The waveform shaping circuit 230 acquires the detection potential signal VX in correspondence with the coupling state designation signals Q1 and Q2. The waveform shaping circuit 230 removes a noise from the acquired detection potential signal VX, amplifies the detection potential signal VX to shape a signal waveform of the detection potential signal VX, and outputs the shaped signal waveform as a detection signal aSK. The AD conversion circuit 231 converts a detection signal aSK of an analog signal output by the waveform shaping circuit 230 into a digital signal and outputs the digital signal as the detection signal SK. The detection signal SK is output from the detection circuit 23 and the print head 25. That is, the detection circuit 23 changes a signal corresponding to a residual vibration generated in the ejection portion D into a digital signal and outputs the digital signal as the detection signal SK.

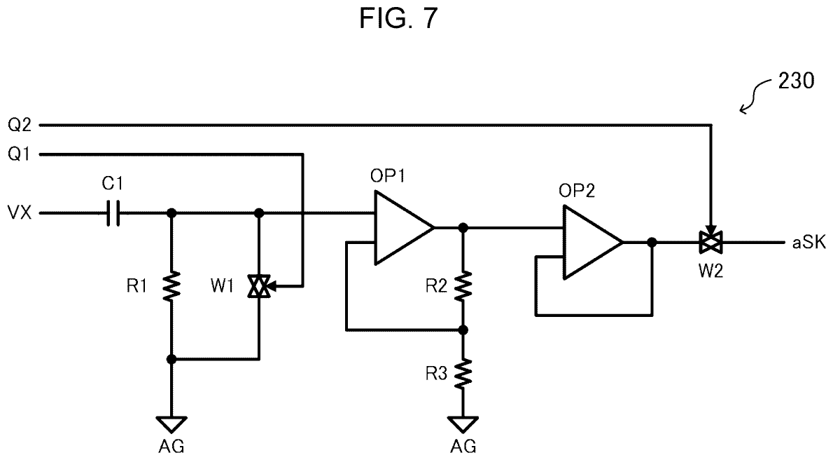

Here, an example of a configuration of the waveform shaping circuit 230 included in the detection circuit 23 will be described. FIG. 7 is a view illustrating an example of the configuration of the waveform shaping circuit 230. As shown in FIG. 7, the waveform shaping circuit 230 includes a capacitor C1, operational amplifiers OP1 and OP2, switches W1 and W2, and resistors R1 to R3.

The detection potential signal VX output by the supply switching circuit 21 is input to one end of the capacitor C1. The other end of the capacitor C1 is electrically coupled to one end of the resistor R1 and one end of the switch W1. The other end of the resistor R1 and the other end of the switch W1 are supplied with an analog ground AG fixed to a constant potential. That is, the resistor R1 and the switch W1 are coupled in parallel. The coupling state designation signal Q1 is input to the control terminal of the switch W1. When the coupling state designation signal Q1 of an H level is input to the control terminal, the switch W1 is conductive between the one end and the other end, and when the coupling state designation signal Q1 of an L level is input to the control terminal, the switch W1 is non-conductive between the one end and the other end. That is, the switch W1 switches a conduction state between the one end of the resistor R1 and the analog ground AG. The capacitor C1, the resistor R1, and the switch W1 configured as described above function as a high-pass filter, and extract and output a signal of a predetermined high frequency component from the detection potential signal VX input in a period in which the switch W1 is controlled to be non-conductive. Here, the switch W1 may be constituted by, for example, the transmission gate as shown in FIG. 5. The analog ground AG may be, for example, a center potential between a power supply potential on a high potential side supplied to the print head 25 and a power supply potential on a low potential side, or may be a ground potential of the print head 25.

A +side input terminal of the operational amplifier OP1 is electrically coupled to a coupling point where the other end of the capacitor C1, the one end of the resistor R1, and the one end of the switch W1 are electrically coupled. That is, a signal output by the high-pass filter including the capacitor C1, the resistor R1, and the switch W1 is input to the +side input terminal of the operational amplifier OP1. A −side input terminal of the operational amplifier OP1 is electrically coupled to a coupling point where one end of the resistor R2 and one end of the resistor R3 are electrically coupled. An output terminal of the operational amplifier OP1 is electrically coupled to the other end of the resistor R2. The analog ground AG is supplied to the other end of the resistor R3. That is, the operational amplifier OP1 and the resistors R2 and R3 function as a non-inverting amplifier circuit that amplifies a signal input to the +side input terminal of the operational amplifier OP1 in correspondence with resistance values of the resistors R2 and R3, and outputs the signal from the output terminal of the operational amplifier OP1. Here, the non-inverting amplifier circuit including the operational amplifier OP1 and the resistors R2 and R3 may be configured to output a signal obtained by superimposing a predetermined offset voltage on a signal output by the high-pass filter including the capacitor C1, the resistor R1, and the switch W1, and then amplifying the signal.

A +side input terminal of the operational amplifier OP2 is electrically coupled to the output terminal of the operational amplifier OP1. That is, a signal output by the non-inverting amplifier circuit configured by the operational amplifier OP1 and the resistors R2 and R3 is input to the +side input terminal of the operational amplifier OP2. A −side input terminal of the operational amplifier OP2 is electrically coupled to an output terminal of the operational amplifier OP2. That is, the operational amplifier OP2 constitutes a voltage follower circuit. As a result, the operational amplifier OP2 converts impedance of the signal output by the non-inverting amplifier circuit including the operational amplifier OP1 and the resistors R2 and R3, and outputs the signal.

One end of the switch W2 is electrically coupled to the output terminal of the operational amplifier OP2. A signal at the other end of the switch W2 is output as the detection signal aSK from the waveform shaping circuit 230. In addition, the coupling state designation signal Q2 is input to the control terminal of the switch W2. When the coupling state designation signal Q2 of an H level is input to the control terminal, the switch W2 becomes conductive between the one end and the other end, and when the coupling state designation signal Q2 of an L level is input to the control terminal, the switch W2 becomes non-conductive between the one end and the other end. The switch W2 switches whether or not to output the signal output by the operational amplifier OP2 as the detection signal aSK from the waveform shaping circuit 230 in correspondence with the logic level of the coupling state designation signal Q2 input to the control terminal.

As described above, the waveform shaping circuit 230 removes a noise component from the detection potential signal VX by the high-pass filter including the capacitor C1, the resistor R1, and the switch W1, and amplifies the signal from which the noise component is removed by the non-inverting amplifier circuit including the operational amplifier OP1, and the resistors R2 and R3. The waveform shaping circuit 230 performs impedance conversion by the voltage follower circuit including the operational amplifier OP2, and then outputs the detection signal aSK. At this time, the switches W1 and W2 switch whether or not the waveform shaping circuit 230 acquires the detection potential signal VX and outputs the detection signal aSK.

The detection signal aSK output by the waveform shaping circuit 230 is input to the AD conversion circuit 231. The AD conversion circuit 231 converts the detection signal aSK into a digital signal. The signal converted into a digital signal by the AD conversion circuit 231 is output from the detection circuit 23 and the print head 25 as the detection signal SK.

In the print head 25 of the present embodiment configured as described above, the supply switching circuit 21 switches whether or not to supply the drive signal Com propagating through the wiring Lc to the piezoelectric element PZ[m] of the ejection portion D[m] as the supply drive signal Vin[m] by controlling the conduction state of the switch Wc[m] in correspondence with the print data signal SI propagated based on the clock signal CL in each of the control periods TQ1 and TQ2 or the control periods TT1 to TT5 defined by the latch signal LAT, the change signal CH, and the period designation signal Tsig. As a result, the drive mode of the ejection portion D[m] is controlled.

In addition, in the print head 25 of the present embodiment, the supply switching circuit 21 switches whether or not to acquire a signal corresponding to the residual vibration generated in the ejection portion D[m] and output the acquired signal to the detection circuit 23 as the detection potential signal VX by controlling the conduction state of the switch Ws[m] in correspondence with the print data signal SI propagated based on the clock signal CL in each of the control periods TQ1 and TQ2 or the control periods TT1 to TT5 defined by the latch signal LAT, the change signal CH, and the period designation signal Tsig. At this time, the detection circuit 23 amplifies and shapes a signal waveform of the input detection potential signal VX in correspondence with the conduction state of the switches W1 and W2, and outputs the signal waveform as the detection signal SK.

That is, the detection circuit 23 acquires an electromotive force generated in the piezoelectric element PZ by displacement of the piezoelectric element PZ in correspondence with the residual vibration generated in the ejection portion D as the detection potential signal VX, and outputs a signal that corresponds to the acquired detection potential signal VX and is obtained by amplifying and shaping the signal waveform of the acquired detection potential signal VX as the detection signal SK.

The detection signal SK output by the detection circuit 23 is input to the determination circuit 60. The determination circuit 60 determines the state of the target ejection portion D[m] based on the input detection signal SK. That is, the liquid ejection apparatus 1 of the present embodiment includes the determination circuit 60 that determines the state of the ejection portion D that is an inspection target in correspondence with the detection signal SK.

Here, the supply switching circuit 21 included in the print head 25 is constituted by one or a plurality of semiconductor devices. In addition, at this time, a part or all of the detection circuit 23 may be mounted on the semiconductor device in combination with the supply switching circuit 21.

As described above, the liquid ejection apparatus 1 of the present embodiment includes the piezoelectric element PZ to which the supply drive signal Vin corresponding to the drive signal Com is supplied, the plurality of ejection portions D that eject ink in correspondence with the driving of the piezoelectric element PZ and outputs a signal corresponding to the residual vibration generated after the piezoelectric element PZ is driven, the detection circuit 23 that acquires any one signal that is output by each of the plurality of ejection portions D and corresponds to the residual vibration generated after the piezoelectric element PZ is driven and output the detection signal SK corresponding to the acquired signal, the switch Ws[1] to Ws[M] that switch whether or not to supply the signal corresponding to the residual vibration generated after the piezoelectric element PZ is driven to the detection circuit 23, and the determination circuit 60 that determines the state of the ejection portion D[m] after correcting the detection signal SK.

### 2.2 Operation of Print Head During Execution of Ejection Process

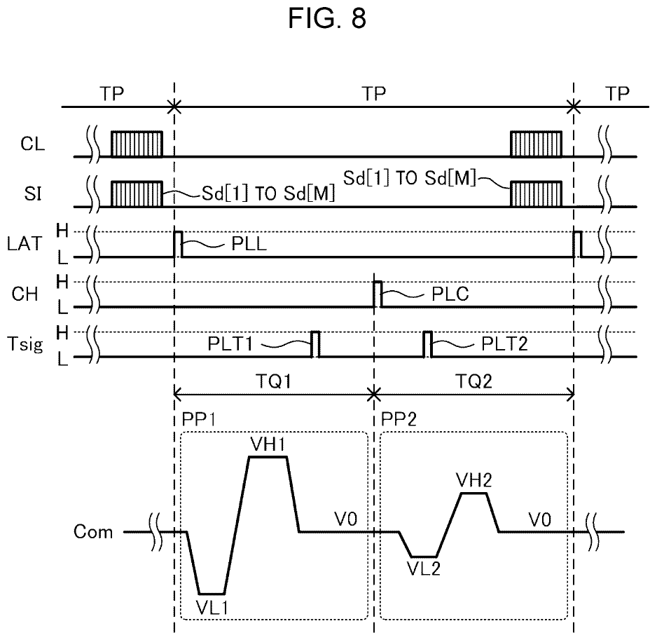

Next, the operation of the print head 25 in a period in which the liquid ejection apparatus 1 executes the ejection process of forming an image corresponding to the image information signal IP on the medium will be described. FIG. 8 is a view illustrating an example of various signals output by the control circuit 30 in the period in which the ejection process is executed.

The control circuit 30 generates the drive waveform designation signal dCom that designates a signal waveform of the drive signal Com output by the drive circuit 40 in a period in which the ejection process is executed, and outputs the drive waveform designation signal dCom to the drive circuit 40. The drive circuit 40 generates the drive signal Com having a signal waveform in which a drive waveform PP1 disposed in the control period TQ1 and a drive waveform PP2 disposed in the control period TQ2 are continuous in each unit period TP as shown in FIG. 8 in correspondence with the input drive waveform designation signal dCom, and supplies the drive signal Com to the print head 25.

The drive waveform PP1 is a signal waveform that starts with a voltage value of a reference potential V0, changes to a potential VL1 lower than the reference potential V0, changes to a potential VH1 higher than the reference potential V0, and then terminates with the reference potential V0. When the drive waveform PP1 is supplied to the piezoelectric element PZ[m], the piezoelectric element PZ[m] is driven such that ink in an ink amount ξ1 is ejected from the nozzle N[m]. That is, the drive waveform PP1 is a signal waveform for ejecting the ink in the ink amount ξ1 from the nozzle N[m].

The drive waveform PP2 is a signal waveform that starts with a voltage value of the reference potential V0, changes to a potential VL2 lower than the reference potential V0, changes to a potential VH2 higher than the reference potential V0, and then terminates with the reference potential V0. When the drive waveform PP2 is supplied to the piezoelectric element PZ[m], the piezoelectric element PZ[m] is driven such that the ink in an ink amount ξ2 that is smaller than the ink amount ξ1 is ejected from the nozzle N[m]. That is, the drive waveform PP2 is a signal waveform for ejecting the ink in the ink amount ξ2 from the nozzle N[m].

Here, in the liquid ejection apparatus 1 of the present embodiment, multi-gradation dots are formed on the medium P by selecting to form any one of a large dot, a medium dot smaller than the large dot, or a small dot smaller than the medium dot, or not to form the dot on the medium P for each unit period TP in the period in which the ejection process is executed. That is, the liquid ejection apparatus 1 of the present embodiment selects whether to eject the ink in an amount corresponding to a large dot, the ink in an amount corresponding to a medium dot, or the ink in an amount corresponding to a small dot, or not to eject the ink from the ejection portion D[m] for each unit period TP in the period in which the ejection process is executed. At this time, in the liquid ejection apparatus 1 of the present embodiment, description will be made on the assumption that the ink amount ξ1 ejected from the ejection portion D[m] when the drive waveform PP1 is supplied to the piezoelectric element PZ[m] is an ink amount corresponding to the medium dot, the ink amount ξ2 ejected from the ejection portion D[m] when the drive waveform PP2 is supplied to the piezoelectric element PZ[m] is an ink amount corresponding to the small dot, and the total amount of the ink amount ξ1 and the ink amount ξ2 is an ink amount corresponding to the large dot.

Further, in the period in which the liquid ejection apparatus 1 of the present embodiment executes the ejection process, the individual designation signal Sd[m] input to the coupling state designation circuit 210 defines the conduction state of the switch Wc[m] in each of the control periods TQ1 and TQ2 to control whether to supply the supply drive signal Vin[m] including the drive waveform PP1 disposed in the control period TQ1 and the drive waveform PP2 disposed in the control period TQ2 to the ejection portion D[m], whether to supply the supply drive signal Vin[m] including the drive waveform PP1 disposed in the control period TQ1 to the ejection portion D[m], whether to supply the supply drive signal Vin[m] including the drive waveform PP2 disposed in the control period TQ2 to the ejection portion D[m], or whether to supply the supply drive signal Vin[m] including neither the drive waveform PP1 disposed in the control period TQ1 nor the drive waveform PP2 disposed in the control period TQ2 to the ejection portion D[m] for each unit period TP. As a result, in the unit period TP in which the liquid ejection apparatus 1 executes the ejection process, whether to eject the ink in an amount corresponding to the large dot, whether to eject the ink in an amount corresponding to the medium dot, whether to eject the ink in an amount corresponding to the small dot, or whether to eject no ink from the ejection portion D[m] is controlled. As a result, a dot size formed on the medium P is controlled.

Here, a relationship between the individual designation signals Sd[1] to Sd[M] included in the print data signal SI input to the coupling state designation circuit 210 and the coupling state designation signals Qc[1] to Qc[M] and Qs[1] to Qs[M] output by the coupling state designation circuit 210 in a period in which the liquid ejection apparatus 1 executes the ejection process will be described with reference to an example of the decoding contents of the individual designation signals Sd[1] to Sd[M] executed by the coupling state designation circuit 210.

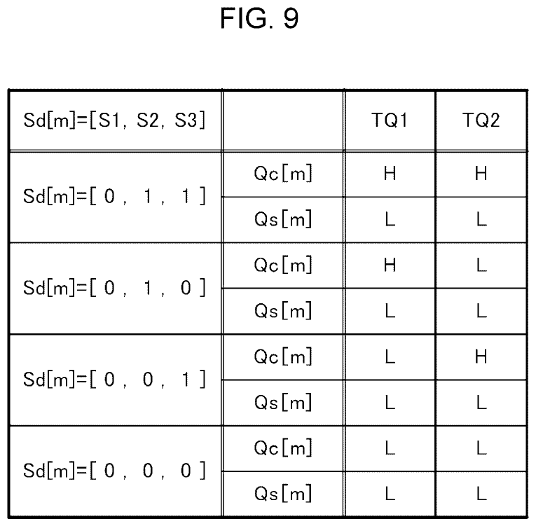

FIG. 9 is a view illustrating an example of the relationship between the individual designation signal Sd[m] and the coupling state designation signals Qc[m] and Qs[m] in the period in which the ejection process is executed.

As shown in FIG. 9, when the individual designation signal Sd[m]=[0, 1, 1] is input to the coupling state designation circuit 210, the coupling state designation circuit 210 generates the coupling state designation signal Qc[m] that is at an H level in the control period TQ1 and is at an H level in the control period TQ2, and outputs the coupling state designation signal Qc[m] to the control terminal of the switch Wc[m]. As a result, the switch Wc[m] is controlled to be conductive in the control period TQ1 and is controlled to be conductive in the control period TQ2. Therefore, the supply drive signal Vin[m] including the drive waveform PP1 is supplied to the piezoelectric element PZ[m] in the control period TQ1, and the supply drive signal Vin[m] including the drive waveform PP2 is supplied to the piezoelectric element PZ[m] in the control period TQ2. As a result, the ink in the ink amount ξ1 is ejected from the nozzle N[m] in the control period TQ1, and the ink in the ink amount ξ2 is ejected from the nozzle N[m] in the control period TQ2. Then, the ink in the ink amount ξ1 ejected in the control period TQ1 and the ink in the ink amount ξ2 ejected in the control period TQ2 land on the medium P and are combined with each other, and thus a large dot is formed on the medium P in the unit period TP.

Further, when the individual designation signal Sd[m]=[0, 1, 0] is input to the coupling state designation circuit 210, the coupling state designation circuit 210 generates the coupling state designation signal Qc[m] that is at an H level in the control period TQ1 and is at an L level in the control period TQ2, and outputs the coupling state designation signal Qc[m] to the control terminal of the switch Wc[m]. As a result, the switch Wc[m] is controlled to be conductive in the control period TQ1 and controlled to be non-conductive in the control period TQ2. Therefore, the supply drive signal Vin[m] including the drive waveform PP1 is supplied to the piezoelectric element PZ[m] in the control period TQ1, and the supply drive signal Vin[m] including the drive waveform PP2 is not supplied to the piezoelectric element PZ[m] in the control period TQ2. Here, in the control period TQ2 in which the supply drive signal Vin[m] including the drive waveform PP2 is not supplied to the piezoelectric element PZ[m], in the upper electrode Zu[m], the reference potential V0, which is a voltage value of the signal supplied immediately before to the upper electrode Zu[m], is held by a capacitive component of the piezoelectric element PZ[m]. That is, in the control period TQ2 in which the supply drive signal Vin[m] including the drive waveform PP2 is not supplied to the piezoelectric element PZ[m], a constant signal at the reference potential V0 is supplied to the upper electrode Zu[m]. As a result, the ink in the ink amount ξ1 is ejected from the nozzle N[m] in the control period TQ1, and the ink is not ejected in the control period TQ2. Then, the ink in the ink amount ξ1 ejected in the control period TQ1 lands on the medium P, and thus the medium dot is formed on the medium P in the unit period TP.

Further, when the individual designation signal Sd[m]=[0, 0, 1] is input to the coupling state designation circuit 210, the coupling state designation circuit 210 generates the coupling state designation signal Qc[m] that is at an L level in the control period TQ1 and is at an H level in the control period TQ2, and outputs the coupling state designation signal Qc[m] to the control terminal of the switch Wc[m]. As a result, the switch Wc[m] is controlled to be non-conductive in the control period TQ1 and is controlled to be conductive in the control period TQ2. Therefore, the supply drive signal Vin[m] including the drive waveform PP1 is not supplied to the piezoelectric element PZ[m] in the control period TQ1, and the supply drive signal Vin[m] including the drive waveform PP2 is supplied to the piezoelectric element PZ[m] in the control period TQ2. Here, in the control period TQ1 in which the supply drive signal Vin[m] including the drive waveform PP1 is not supplied to the piezoelectric element PZ[m], the upper electrode Zu[m] holds the reference potential V0, which is a voltage value of the signal supplied immediately before to the upper electrode Zu[m], by the capacitive component of the piezoelectric element PZ[m]. That is, in the control period TQ1 in which the supply drive signal Vin[m] including the drive waveform PP1 is not supplied to the piezoelectric element PZ[m], a constant signal at the reference potential V0 is supplied to the upper electrode Zu[m]. As a result, the ink is not ejected from the nozzle N[m] in the control period TQ1, and the ink in the ink amount ξ2 is ejected from the nozzle N[m] in the control period TQ2. Then, the ink in the ink amount ξ2 ejected in the control period TQ2 lands on the medium P, and thus the small dot is formed on the medium P in the unit period TP.

Further, when the individual designation signal Sd[m]=[0, 0, 0] is input to the coupling state designation circuit 210, the coupling state designation circuit 210 generates the coupling state designation signal Qc[m] that is at an L level in the control period TQ1 and is at an L level in the control period TQ2, and outputs the coupling state designation signal Qc[m] to the control terminal of the switch Wc[m]. As a result, the switch Wc[m] is controlled to be non-conductive in the control period TQ1 and is controlled to be non-conductive in the control period TQ2. Therefore, the supply drive signal Vin[m] including the drive waveform PP1 is not supplied to the piezoelectric element PZ[m] in the control period TQ1, and the supply drive signal Vin[m] including the drive waveform PP2 is not supplied to the piezoelectric element PZ[m] in the control period TQ2. Here, in the control period TQ1 in which the supply drive signal Vin[m] including the drive waveform PP1 is not supplied to the piezoelectric element PZ[m] and the control period TQ2 in which the supply drive signal Vin[m] including the drive waveform PP2 is not supplied to the piezoelectric element PZ[m], the upper electrode Zu[m] holds the reference potential V0, which is a voltage value of the signal supplied immediately before to the upper electrode Zu[m], by the capacitive component of the piezoelectric element PZ[m]. That is, in the control period TQ1 in which the supply drive signal Vin[m] including the drive waveform PP1 is not supplied to the piezoelectric element PZ[m], and in the control period TQ2 in which the supply drive signal Vin[m] including the drive waveform PP2 is not supplied, a constant signal at the reference potential V0 is supplied to the upper electrode Zu[m]. As a result, the ink is not ejected from the nozzle N[m] in the control period TQ1, and the ink is not ejected from the nozzle N[m] in the control period TQ2. Therefore, a dot is not formed on the medium P in the unit period TP.

As described above, when the liquid ejection apparatus 1 executes the ejection process, in each of the control periods TQ1 and TQ2 in the unit period TP, the coupling state designation circuit 210 outputs the coupling state designation signals Qc[1] to Qc[M] of logic levels based on the individual designation signals Sd[1] to Sd[M]. As a result, the conduction state of each of the switches Wc[1] to Wc[M] in the control periods TQ1 and TQ2 in the unit period TP is controlled, and the ejection amount of the ink ejected from each of the ejection portions D[1] to D[M] in the control periods TQ1 and TQ2 in the unit period TP is controlled. That is, the dot size formed on the medium P in the unit period TP is controlled. As a result, the liquid ejection apparatus 1 can form an image corresponding to the image information signal IP on the medium P in the period in which the ejection process is executed.

Here, as shown in FIG. 9, in the period in which the liquid ejection apparatus 1 executes the ejection process, the coupling state designation circuit 210 continues to output the coupling state designation signal Qs[m] of an L level regardless of the input individual designation signal Sd[m]. Therefore, the switch Ws[m] is controlled to be non-conductive in the period in which the ejection process is executed. As a result, the upper electrode Zu[m] and the wiring Ls are not electrically coupled to each other in the period in which the liquid ejection apparatus 1 executes the ejection process, and thus a signal corresponding to the residual vibration generated in the ejection portion D[m] is not supplied to the detection circuit 23. Therefore, the detection circuit 23 does not acquire the detection potential signal VX in the period in which the liquid ejection apparatus 1 executes the ejection process. Therefore, although not illustrated, the coupling state designation circuit 210 continues to output the coupling state designation signals Qf, Q1, and Q2 of an L level in the period in which the liquid ejection apparatus 1 executes the ejection process.

### 2.3 Operation of Print Head During Execution of Determination Process

Next, the determination process of determining the state of the ejection portion D that ejects the ink to the medium P will be described. It is known that residual vibration occurs in an ejection portion that ejects a liquid such as ink by driving a drive element such as a piezoelectric element after the drive element is driven. The residual vibration generated in the ejection portion is so-called attenuation vibration in which the amplitude decreases with the passage of time, and waveform information such as the amplitude, an amplitude attenuation rate, a cycle, and a frequency of the attenuation vibration changes depending on the state of the ejection portion. For example, when the viscosity of the liquid stored in the ejection portion is changed, the amplitude of the residual vibration generated in the ejection portion or the amplitude attenuation rate is changed, or when, for example, air bubbles are mixed in the ejection portion, the frequency of the residual vibration generated in the ejection portion is increased.

In the liquid ejection apparatus 1 of the present embodiment, in the determination process of determining the state of the ejection portion D that ejects the ink to the medium, the supply switching circuit 21 included in the print head 25 acquires a signal corresponding to the residual vibration generated in the ejection portion D[m] that is an inspection target and outputs the signal to the detection circuit 23 as the detection potential signal VX, and the detection circuit 23 generates the detection signal SK by shaping a signal waveform of the input detection potential signal VX. Then, based on the input detection signal SK, the determination circuit 60 calculates waveform information such as an amplitude, a cycle, a frequency, and the like of the residual vibration generated in the ejection portion D[m] that is an inspection target which is waveform information such as an amplitude, a cycle, a frequency, and the like of the detection potential signal VX, and determines the state of the ejection portion D[m] that is an inspection target based on the calculated waveform information. Thereafter, the determination circuit 60 generates the state determination signal JH indicating the determination result and outputs the state determination signal JH to the control circuit 30. As a result, the control circuit 30 can acquire the state of the ejection portion D[m] that is an inspection target, correct the various signals to be output in correspondence with the acquired state of the ejection portion D[m] that is an inspection target, or notify a user of the state of the ejection portion D[m] that is an inspection target.

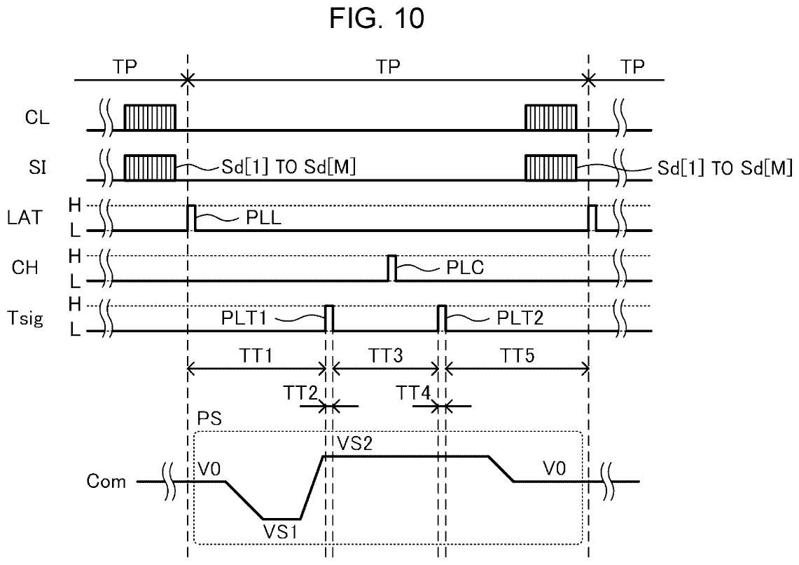

FIG. 10 is a view illustrating an example of various signals input to the supply switching circuit 21 of the print head 25 in the period in which the determination process is executed.

The control circuit 30 generates the drive waveform designation signal dCom that designates a signal waveform of the drive signal Com output by the drive circuit 40 in the period in which the determination process is executed, and outputs the drive waveform designation signal dCom to the drive circuit 40. The drive circuit 40 generates the drive signal Com including a drive waveform PS for each unit period TP as shown in FIG. 10 in correspondence with the input drive waveform designation signal dCom, and supplies the drive signal Com to the print head 25.

The drive waveform PS is a signal waveform in which a voltage value starts with the reference potential V0, changes to a potential VS1 having a potential lower than the reference potential V0, and becomes a potential VS2 having a potential higher than the reference potential V0 in the control period TT1, and maintains the potential VS2 in the control periods TT2, TT3, and TT4, and terminates at the reference potential V0 in the control period TT5. When the drive waveform PS is supplied to the piezoelectric element PZ[m], the piezoelectric element PZ[m] is driven such that the ink is not ejected from the nozzle N[m], and the residual vibration occurs in the ejection portion D[m] at a timing when the voltage value of the drive signal Com becomes the potential VS2 after the piezoelectric element PZ[m] is driven. That is, the drive waveform PS is a signal waveform for driving the piezoelectric element PZ[m] such that the ink is not ejected from the nozzle N[m] and the predetermined residual vibration is generated in the ejection portion D[m], and the piezoelectric element PZ[m] is driven such that the ink is not ejected from the ejection portion D[m] and the residual vibration is generated when the drive waveform PS is supplied.

Then, in the period in which the liquid ejection apparatus 1 executes the determination process, the coupling state designation circuit 210 controls the conduction state of each of the switches Wc[1] to Wc[M], Ws[1] to Ws[M], Wf, W1, and W2 based on the individual designation signals Sd[1] to Sd[M] included in the print data signal SI in each of the control periods TT1 to TT5 to supply the supply drive signal Vin[m] including the drive waveform PS to the ejection portion D[m] that is an inspection target, acquires a signal corresponding to the residual vibration generated in the ejection portion D[m] that is an inspection target due to the supply of the supply drive signal Vin[m] including the drive waveform PS, and outputs the acquired signal to the detection circuit 23 as the detection potential signal VX. The detection circuit 23 generates the detection signal SK by shaping a signal waveform of the input detection potential signal VX, and the determination circuit 60 determines the state of the ejection portion D[m] that is an inspection target based on the detection signal SK.

Here, a relationship between the individual designation signals Sd[1] to Sd[M] included in the print data signal SI input to the coupling state designation circuit 210, the coupling state designation signals Qc[1] to Qc[M], Qs[1] to Qs[M], Qf, Q1, and Q2 output by the coupling state designation circuit 210 in a period in which the liquid ejection apparatus 1 executes the determination process will be described with reference to an example of the decoding contents of the individual designation signals Sd[1] to Sd[M] executed in the period in which the determination process is executed by the coupling state designation circuit 210.

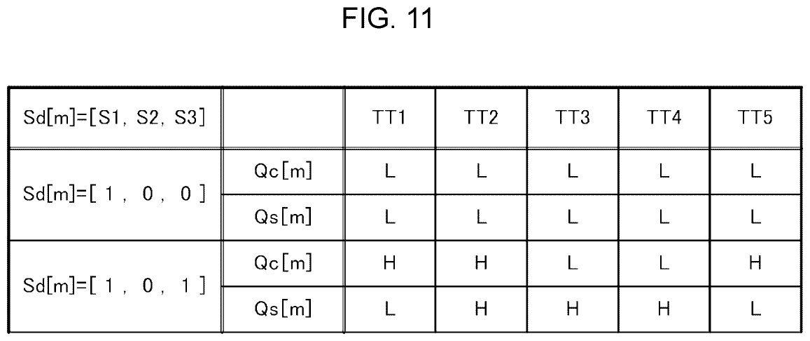

FIG. 11 is a view illustrating an example of the relationship between the individual designation signal Sd[m] and the coupling state designation signals Qc[m] and Qs[m] in the period in which the determination process is executed. Here, in the liquid ejection apparatus 1 of the present embodiment, the control circuit 30 outputs the individual designation signal Sd[m]=[1, 0, 0] to the coupling state designation circuit 210 when the ejection portion D[m] is not the inspection target in the period in which the determination process is executed, and outputs the individual designation signal Sd[m]=[1, 0, 1] to the coupling state designation circuit 210 when the ejection portion D[m] is the inspection target.

As shown in FIG. 11, when the individual designation signal Sd[m]=[1, 0, 0] is input to the coupling state designation circuit 210, the coupling state designation circuit 210 generates the coupling state designation signal Qc[m] that becomes an L level in the control periods TT1 to TT5, outputs the coupling state designation signal Qc[m] to the control terminal of the switch Wc[m], generates the coupling state designation signal Qs[m] that becomes an L level in the control periods TT1 to TT5, and outputs the coupling state designation signal Qs[m] to the control terminal of the switch Ws[m]. As a result, the switch Wc[m] is controlled to be non-conductive in the control periods TT1 to TT5, and the switch Ws[m] is controlled to be non-conductive. At this time, the supply drive signal Vin[m] corresponding to the drive signal Com is not supplied to the piezoelectric element PZ[m] of the ejection portion D[m] that is not an inspection target. Therefore, the residual vibration does not occur in the ejection portion D[m] that is not an inspection target, and in this case, even when the potential of the upper electrode Zu[m] of the piezoelectric element PZ[m] included in the ejection portion D[m] that is not an inspection target changes, the signal accompanying the change in the potential is not supplied to the wiring Ls. Therefore, the determination of the state of the ejection portion D[m] that is not the inspection target is not executed.

Further, when the individual designation signal Sd[m]=[1, 0, 1] is input to the coupling state designation circuit 210, the coupling state designation circuit 210 generates the coupling state designation signal Qc[m] that is at an H level in the control periods TT1, TT2, and TT5 and is at an L level in the control periods TT3 and TT4, outputs the coupling state designation signal Qc[m] to the control terminal of the switch Wc[m], generates the coupling state designation signal Qs[m] that is at an H level in the control periods TT2 to TT4 and is at an L level in the control periods TT1 and TT5, and outputs the coupling state designation signal Qs[m] to the control terminal of the switch Ws[m]. As a result, the switch Wc[m] is controlled to be conductive in the control periods TT1, TT2, and TT5 and is controlled to be non-conductive in the control periods TT3 and TT4, and the switch Ws[m] is controlled to be conductive in the control periods TT2 to TT4 and is controlled to be non-conductive in the control periods TT1 and TT5.

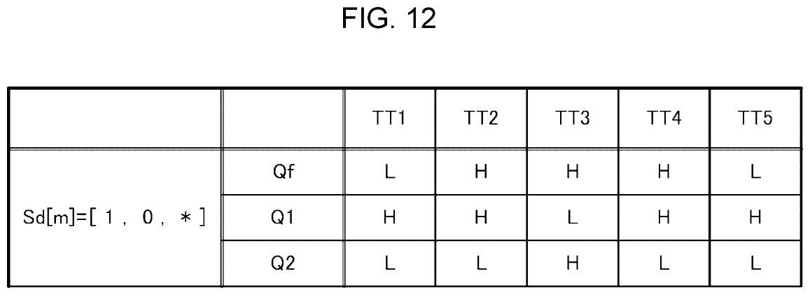

FIG. 12 is a view illustrating an example of a relationship between the individual designation signal Sd[m] and the coupling state designation signals Qf, Q1, and Q2 in a period in which the determination process is executed. Here, in the period in which the determination process is executed, the coupling state designation circuit 210 outputs the coupling state designation signals Qf, Q1, and Q2 of the same logic level in each of the control periods TT1 to TT5 when the individual designation signal Sd[m]=[1, 0, 0] is input and when the individual designation signal Sd[m]=[1, 0, 1] is input. Therefore, in FIG. 12, the individual designation signal Sd[m]=[1, 0, 0] and the individual designation signal Sd[m]=[1, 0, 1] are collectively illustrated as the individual designation signal Sd[m]=[1, 0, *].

As shown in FIG. 12, when the individual designation signal Sd[m]=[1, 0, *] is input to the coupling state designation circuit 210, the coupling state designation circuit 210 generates the coupling state designation signal Qf that is at an H level in the control periods TT2 to TT4 and is at an L level in the control periods TT1 and TT5, outputs the coupling state designation signal Qf to the control terminal of the switch Wf, generates the coupling state designation signal Q1 that is at an H level in the control periods TT1, TT2, TT4, and TT5 and is at an L level in the control period TT3, outputs the coupling state designation signal Q1 to the control terminal of the switch W1, generates the coupling state designation signal Q2 that is at an H level in the control period TT3 and is at an L level in the control periods TT1, TT2, TT4, and TT5, and outputs the coupling state designation signal Q2 to the control terminal of the switch W2. As a result, the switch Wf is controlled to be conductive in the control periods TT2 to TT4 and controlled to be non-conductive in the control periods TT1 and TT5, the switch W1 is controlled to be conductive in the control periods TT1, TT2, TT4, and TT5 and controlled to be non-conductive in the control period TT3, and the switch W2 is controlled to be conductive in the control period TT3 and controlled to be non-conductive in the control periods TT1, TT2, TT4, and TT5.

Here, an operation of the liquid ejection apparatus 1 when the individual designation signal Sd[m]=[1, 0, 1] is input to the coupling state designation circuit 210 will be described as an example of an acquisition operation in which the detection circuit 23 acquires the detection potential signal VX based on a signal corresponding to the residual vibration generated in the ejection portion D[m] that is an inspection target.

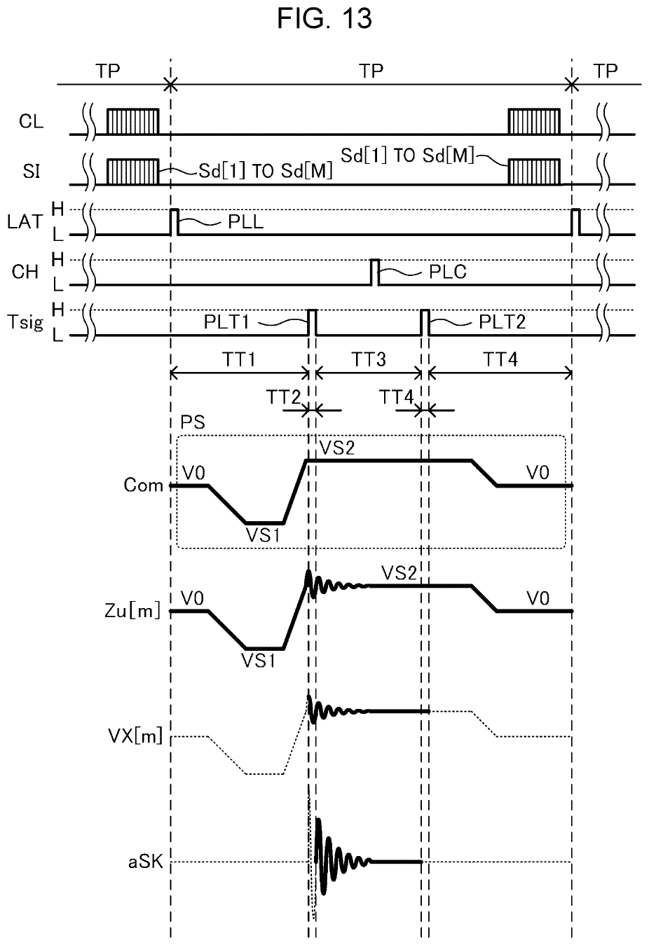

FIG. 13 is a diagram for describing an example of an operation of acquiring the detection potential signal VX based on the signal corresponding to the residual vibration generated in the ejection portion D[m] that is an inspection target. As shown in FIG. 13, for each unit period TP in a period in which the determination process is executed, the coupling state designation circuit 210 is supplied with the drive signal Com including the drive waveform PS in which a voltage value starts with the reference potential V0, changes to the potential VS1 having a potential lower than the reference potential V0, and becomes the potential VS2 having a potential higher than the reference potential V0 in the control period TT1, maintains the potential VS2 in the control periods TT2 to TT4, and terminates at the reference potential V0 in the control period TT5.

Then, in the period in which the determination process is executed, the control circuit 30 outputs the individual designation signal Sd[m]=[1, 0, 1] corresponding to the ejection portion D[m] that is an inspection target to the coupling state designation circuit 210. At this time, the ejection portions D[1] to D[m−1] and D[m+1] to D[M] are not inspection targets. That is, the control circuit 30 outputs the individual designation signals Sd[1] to Sd[m−1], Sd[m+1] to Sd[M]=[1, 0, 0] to the coupling state designation circuit 210.

When the print data signal SI including the individual designation signal Sd[m]=[1, 0, 1] and the individual designation signals Sd[1] to Sd[m−1], Sd[m+1] to Sd[M]=[1, 0, 0] is input to the coupling state designation circuit 210, the switch Wc[m] is controlled to be conductive and the switches Wc[1] to Wc[m−1] and Wc[m+1] to Wc[M] are controlled to be non-conductive in the control periods TT1 and TT2. Therefore, the upper electrode Zu[m] is supplied with the supply drive signal Vin[m] in which a voltage value starts with the reference potential V0, changes to the potential VS1 having a potential lower than the reference potential V0, becomes the potential VS2 having a potential higher than the reference potential V0, and maintains the potential VS2 in the control periods TT1 and TT2, and then, the reference potential V0 is held in the upper electrodes Zu[1] to Zu[m−1] and Zu[m+1] to Zu[M]. At this time, in the ejection portion D[m] that is an inspection target, the residual vibration occurs at the timing at which the voltage value of the supply drive signal Vin[m] that is supplied is constant at the potential VS2. The piezoelectric substance Zm[m] is deformed in correspondence with the residual vibration generated in the ejection portion D[m] that is an inspection target, and an electromotive force corresponding to the deformation of the piezoelectric substance Zm[m] is generated in the upper electrode Zu[m]. That is, a signal corresponding to the residual vibration generated in the ejection portion D[m] that is an inspection target is generated in the upper electrode Zu[m] of the piezoelectric element PZ[m] included in the ejection portion D[m] that is an inspection target. In other words, the ejection portion D[m] includes the piezoelectric element PZ[m] that outputs a signal corresponding to the electromotive force corresponding to the residual vibration.

In the control period TT2, the switch Ws[m] is controlled to be conductive, the switches Ws[1] to Ws[m−1] and Ws[m+1] to Ws[M] are controlled to be non-conductive, and the switch Wf is controlled to be conductive, and thus a signal corresponding to the residual vibration generated in the ejection portion D[m] that is an inspection target propagates through the wiring Ls as the detection potential signal VX. At this time, the switch W1 is controlled to be conductive, and the switch W2 is controlled to be non-conductive. Therefore, in the control period TT2, the waveform shaping circuit 230 included in the detection circuit 23 does not acquire the detection potential signal VX propagating through the wiring Ls, and thus, does not output the detection signal aSK corresponding to the detection potential signal VX.

In the control period TT3, the switch W1 is controlled to be non-conductive and the switch W2 is controlled to be conductive, and thus the waveform shaping circuit 230 included in the detection circuit 23 acquires the detection potential signal VX that is a signal corresponding to the residual vibration generated in the ejection portion D[m] that is an inspection target and propagates through the wiring Ls, shapes the signal waveform of the acquired detection potential signal VX, and outputs the shaped signal waveform as the detection signal aSK. The detection signal aSK output by the waveform shaping circuit 230 is converted into a digital signal in the AD conversion circuit 231, and then is input to the determination circuit 60 as the detection signal SK.

Based on the input detection signal SK, the determination circuit 60 calculates waveform information such as an amplitude, a cycle, and a frequency of the residual vibration generated in the ejection portion D[m] that is an inspection target which is waveform information such as an amplitude, a cycle, and a frequency of the detection potential signal VX. The determination circuit 60 determines the state of the ejection portion D[m] that is an inspection target based on the calculated waveform information, and outputs the state determination signal JH indicating the determination result to the control circuit 30.

In the subsequent control period TT4, the switch W1 is controlled to be conductive and the switch W2 is controlled to be non-conductive, and thus the waveform shaping circuit 230 stops acquisition of the detection potential signal VX propagating through the wiring Ls and output of the detection signal aSK. In the control period TT5, the switch Wc[m] is controlled to be conductive and the switch Ws[m] is controlled to be non-conductive, and thus supply of a signal generated in the upper electrode Zu[m] to the wiring Ls is stopped, and the supply drive signal Vin[m] of the reference potential V0 is supplied to the upper electrode Zu[m] of the piezoelectric element PZ[m] included in the ejection portion D[m] that is an inspection target. As a result, the potential of the upper electrode Zu[m] of the piezoelectric element PZ[m] included in the ejection portion D[m] that is an inspection target is controlled to the reference potential V0.

### 3. Configuration and Operation of Power Supply Circuit

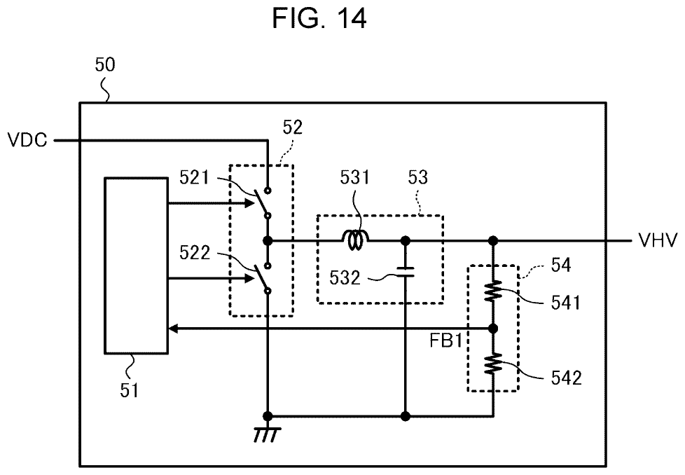

Next, a functional configuration of the power supply circuit 50 will be described. FIG. 14 is a view illustrating an example of a functional configuration of the power supply circuit 50. As shown in FIG. 14, the power supply circuit 50 includes a control circuit 51, a switching circuit 52, a smoothing circuit 53, and a feedback circuit 54, the switching circuit 52 includes transistors 521 and 522, the smoothing circuit 53 includes an inductor 531 and a capacitor 532, and the feedback circuit 54 includes resistors 541 and 542. The power supply circuit 50 receives the power supply voltage signal VDC and outputs the power supply voltage signal VHV.

A feedback signal FB1 to be described later, which is output by the feedback circuit 54, is input to the control circuit 51. The control circuit 51 outputs a signal for controlling the conduction state of each of the transistors 521 and 522 included in the switching circuit 52 in correspondence with the voltage value of the input feedback signal FB1.

For example, an n-channel type metal-oxide-semiconductor field-effect transistor (MOS-FET) is used as the transistors 521 and 522. The power supply voltage signal VDC is input to a drain terminal that is one end of the transistor 521. A source terminal, which is the other end of the transistor 521, is electrically coupled to a drain terminal that is one end of the transistor 522. A ground potential is supplied to a source terminal that is the other end of the transistor 522. In addition, a signal for controlling the conduction state of each of the transistors 521 and 522 output by the control circuit 51 is input to a gate terminal that is a control terminal controlling the conduction state between the drain terminal and the source terminal of the transistor 521, and a gate terminal that is a control terminal controlling the conduction state between the drain terminal and the source terminal of the transistor 522. That is, since the conduction state of each of the transistors 521 and 522 is controlled under control by the control circuit 51, the switching circuit 52 outputs a pulse signal in which a voltage value switches between a voltage value of the power supply voltage signal VDC and the ground potential from a coupling point where the source terminal of the transistor 521 and the drain terminal of the transistor 522 are electrically coupled to each other. In other words, the switching circuit 52 outputs a pulse signal corresponding to the power supply voltage signal VDC.

One end of the inductor 531 is electrically coupled to the source terminal of the transistor 521 and the drain terminal of the transistor 522. The other end of the inductor 531 is electrically coupled to one end of the capacitor 532. The ground potential is supplied to the other end of the capacitor 532. That is, the smoothing circuit 53 constitutes a low pass filter including the inductor 531 and the capacitor 532. The smoothing circuit 53 smooths a signal generated at the coupling point where the source terminal of the transistor 521 and the drain terminal of the transistor 522 are electrically coupled, the signal being the pulse signal described above. That is, the smoothing circuit 53 includes the capacitor 532 and outputs the power supply voltage signal VHV obtained by smoothing the pulse signal. The signal smoothed by the smoothing circuit 53 is output as the power supply voltage signal VHV from the power supply circuit 50.

One end of the resistor 541 is electrically coupled to the other end of the inductor 531 and the one end of the capacitor 532. The other end of the resistor 541 is electrically coupled to one end of the resistor 542. The ground potential is supplied to the other end of the resistor 542. A potential of a coupling point where the other end of the resistor 541 and the one end of the resistor 542 are electrically coupled to each other is input to the control circuit 51 as the feedback signal FB1. That is, the feedback circuit 54 divides a voltage value of the coupling point at which the other end of the inductor 531 and the one end of the capacitor 532 are electrically coupled, which is a voltage value of the power supply voltage signal VHV output by the power supply circuit 50, by the resistor 541 and the resistor 542, and feeds back the divided voltage value to the control circuit 51.

An operation of the power supply circuit 50 configured as described above will be described. When the voltage value of the feedback signal FB1 input from the feedback circuit 54 is higher than a predetermined voltage value, the control circuit 51 outputs a signal for controlling the transistor 521 to be non-conductive between the drain terminal and the source terminal and a signal for controlling the transistor 522 to be conductive between the drain terminal and the source terminal. At this time, the voltage value of the coupling point where the source terminal of the transistor 521 and the drain terminal of the transistor 522 are electrically coupled to each other is the ground potential. Therefore, the voltage value of the power supply voltage signal VHV output from the smoothing circuit 53 decreases. When the voltage value of the feedback signal FB1 input from the feedback circuit 54 is lower than a predetermined voltage value, the control circuit 51 outputs a signal for controlling the transistor 521 to be conductive between the drain terminal and the source terminal and a signal for controlling the transistor 522 to be non-conductive between the drain terminal and the source terminal. At this time, the voltage value of the coupling point where the source terminal of the transistor 521 and the drain terminal of the transistor 522 are electrically coupled to each other is the voltage value of the power supply voltage signal VDC. Therefore, the voltage value of the power supply voltage signal VHV output from the smoothing circuit 53 increases.

That is, the power supply circuit 50 generates and outputs the power supply voltage signal VHV in which the voltage value is constant at a predetermined voltage value by controlling the conduction state of the transistors 521 and 522 such that the voltage value of the power supply voltage signal VHV, which is the voltage value of the feedback signal FB1 input from the feedback circuit 54, is a constant value. In other words, the power supply circuit 50 includes a DC/DC converter including a switching power supply circuit. The configuration of the power supply circuit 50 is not limited to the configuration illustrated in FIG. 14, and may be, for example, a configuration in which a diode is used instead of the transistor 522.

As described above, in the liquid ejection apparatus 1 of the present embodiment, the power supply circuit 50 includes the switching power supply circuit, generates the power supply voltage signal VHV from the power supply voltage signal VDC by the operation of the switching power supply circuit, and outputs the power supply voltage signal VHV. In the power supply circuit 50 including the switching power supply circuit, power consumption can be reduced as compared with a case where the power supply circuit includes a linear power supply circuit. On the other hand, in the power supply circuit 50 including the switching power supply circuit, the switching circuit 52 generates a pulse signal in which the voltage value switches between the voltage value of the power supply voltage signal VDC and the ground potential, and the smoothing circuit 53 smooths the pulse signal to generate the power supply voltage signal VHV, and thus a ripple voltage is superimposed on the output power supply voltage signal VHV.

Here, as shown in FIG. 2, the power supply voltage signal VHV output by the power supply circuit 50 is supplied to each portion of the ejection unit 5. Therefore, there is a concern that the ripple voltage superimposed on the power supply voltage signal VHV output by the power supply circuit 50 may affect stability of the operation of the liquid ejection apparatus 1.

Specifically, the power supply voltage signal VHV is input to the drive circuit 40. The drive circuit 40 generates the drive signal Com by amplifying the signal waveform defined by the drive waveform designation signal dCom in correspondence with the input power supply voltage signal VHV, and outputs the drive signal Com. Therefore, when the ripple voltage is superimposed on the power supply voltage signal VHV, the ripple voltage is superimposed on the signal waveform of the drive signal Com output by the drive circuit 40 and the signal waveform of the supply drive signal Vin[m] corresponding to the drive signal Com. As a result, there is a concern that the drive accuracy of the piezoelectric element PZ[m] driven by the supply drive signal Vin[m] may be lowered, and there is a concern that the ejection accuracy of the ink ejected from the ejection portion D[m] by driving of the piezoelectric element PZ[m] may also be lowered.

In addition, the power supply voltage signal VHV is also supplied to the gate terminals of the transistors Wnm and Wpm included in each of the switches Wc[m] and Ws[m] as the coupling state designation signals Qc[m] and Qs[m], and is also supplied to the back gate terminal of the transistor Wpm included in each of the switches Wc[m] and Ws[m]. At this time, there is a concern that the ripple voltage superimposed on the power supply voltage signal VHV may be superimposed on the drive signal Com propagating through the wiring Lc via a parasitic capacitance between the gate terminal, and the drain terminal and the source terminal of the transistors Wnm and Wpm, a parasitic capacitance between the back gate terminal, and the drain terminal and the source terminal of the transistor Wpm, and the like, or the detection potential signal VX that is a signal propagating through the wiring Ls and corresponding to the residual vibration generated in the ejection portion D[m] that is an inspection target. As a result, there is a concern that waveform accuracy of the signal waveform of the drive signal Com and the signal waveform of the supply drive signal Vin[m] corresponding to the drive signal Com may be lowered, and ejection accuracy of the ink ejected from the ejection portion D[m] by driving of the piezoelectric element PZ[m] may be lowered, and there is also a concern that determination accuracy of the state of the ejection portion D[m] that is an inspection target in the determination circuit 60 may be lowered.

As described above, there is a concern that the stability of the operation of the liquid ejection apparatus 1 may be lowered due to the influence of the ripple voltage superimposed on the power supply voltage signal VHV.

In particular, a voltage amplitude of the detection potential signal VX, which is a voltage amplitude of the signal corresponding to the residual vibration generated in the ejection portion D[m] that is an inspection target, is approximately several tens of mV to 100 mV, whereas a voltage amplitude of the ripple voltage superimposed on the power supply voltage signal VHV output by the power supply circuit 50 reaches several tens of mV to 100 mV in some cases. When the ripple voltage superimposed on the power supply voltage signal VHV is superimposed on the detection potential signal VX, which is a signal corresponding to the residual vibration generated in the ejection portion D[m] that is an inspection target, the waveform information such as the amplitude, the amplitude attenuation rate, the cycle, and the frequency of the detection potential signal VX changes significantly. As a result, there is a concern that the determination accuracy of the state of the ejection portion D[m] that is an inspection target in the determination circuit 60 may be significantly lowered.

On the other hand, in the liquid ejection apparatus of the present embodiment, the capacitor 532 included in the power supply circuit 50 has a characteristic structure, and thus the voltage amplitude of the ripple voltage superimposed on the power supply voltage signal VHV output by the power supply circuit 50 can be reduced. As a result, the possibility that the operational stability of the liquid ejection apparatus 1 is lowered due to the influence of the ripple voltage superimposed on the power supply voltage signal VHV is reduced. The characteristic structure of the capacitor 532 included in the power supply circuit 50 will be described.

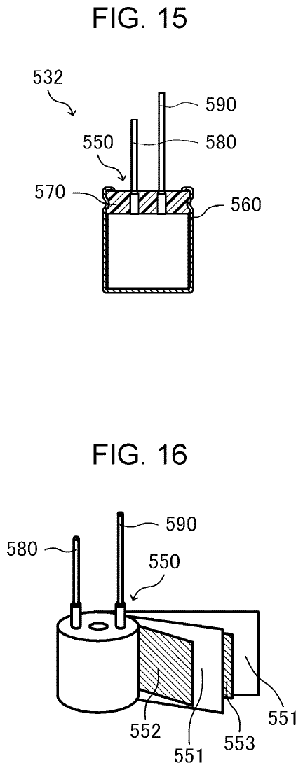

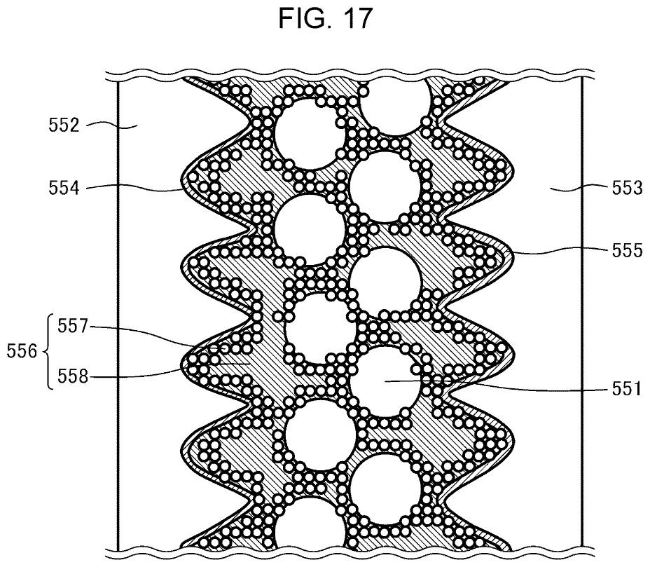

FIGS. 15, 16, and 17 are views illustrating an example of the structure of the capacitor 532 included in the power supply circuit 50. FIG. 15 is a cross-sectional view of the capacitor 532, FIG. 16 is a partially exploded perspective view of a capacitor element 550 included in the capacitor 532, and FIG. 17 is a cross-sectional view illustrating a main portion of the capacitor 532.

As shown in FIG. 15, the capacitor 532 includes the capacitor element 550, an exterior case 560, a sealing member 570, and lead terminals 580 and 590.

The exterior case 560 is a bottomed cylindrical shape in which one surface formed of metal or the like is opened, and the capacitor element 550 is accommodated inside the exterior case 560. A bottom surface portion of the exterior case 560 has a substantially circular shape, and a valve (not illustrated) is formed in the vicinity of the center. The valve is released when an internal pressure of the exterior case 560 is increased. As a result, the internal pressure of the exterior case 560 is reduced. A side surface portion of the exterior case 560 is erected in a direction substantially perpendicular to an outer edge of the bottom surface portion. An opening portion of the exterior case 560 is sealed by the sealing member 570. The capacitor element 550 is accommodated in a space formed by the exterior case 560 and the sealing member 570. Two through-holes are formed in the sealing member 570. The lead terminal 580 is inserted through one of the two through-holes formed in the sealing member 570, and the lead terminal 590 is inserted through the other through-hole of the two through-holes formed in the sealing member 570. In addition, the capacitor element 550 is coupled to one end of the lead terminals 580 and 590. That is, the other end of each of the lead terminals 580 and 590 is drawn out to the outside of the exterior case 560 in a state in which one end of each is coupled to the capacitor element 550.

As shown in FIG. 16, the capacitor element 550 includes an anode foil 552, cathode foil 553, and separator 551. The separator 551 is disposed between the anode foil 552 and the cathode foil 553. The capacitor element 550 is configured by winding the anode foil 552 and the cathode foil 553 in a laminated manner via the separator 551.

The anode foil 552 is formed of a valve metal such as aluminum, tantalum, or niobium. After a surface of the anode foil 552 is roughened by etching, an oxide film 554 as shown in FIG. 17 is formed by a chemical conversion treatment. The cathode foil 553 is formed of a valve metal such as aluminum, tantalum, or niobium in a similar manner as in the anode foil 552. A surface of the cathode foil 553 is roughened by etching in a similar manner in the anode foil 552, and then an oxide film 555 as shown in FIG. 17 is formed by a natural oxidation or a chemical conversion treatment. Each of the anode foil 552 and the cathode foil 553 is electrically coupled to each of corresponding lead terminals 580 and 590.

A width of the separator 551 is larger than a winding width of the anode foil 552 and the cathode foil 553, and two pieces of the separators 551 are overlapped to sandwich the anode foil 552 and the cathode foil 553. As the separator 551, for example, a separator formed of cellulose fibers which are chemically compatible with a liquid substance such as conductive polymer particles or a hydrophilic polymer compound is preferably used.

Specifically, the separator 551 is formed of a sheet-shaped electrically insulating material having pores or voids, and is disposed between the anode foil 552 and the cathode foil 553. As a result, the separator 551 prevents short-circuit between the anode foil 552 and the cathode foil 553. In addition, in the separator 551, as an electrolyte 556 to be described later, a solid electrolyte 557 and a liquid substance 558 are held in the pores or voids. As the separator 551, a sheet-like structure having voids at the inside, for example, a paper sheet, a nonwoven fabric, a foamed body, or the like can be used.

Here, a base material of the separator 551 may be an electrically insulating material, but is preferably a base material containing a polymer having a hydroxyl group as a main component. As a result, the separator 551 is a liquid substance such as a conductive polymer particle or a hydrophilic polymer compound, and is chemically more likely to be compatible with the electrolyte 556 described later. As the base material containing such a polymer having a hydroxyl group as the main component, for example, a natural fiber, a regenerated fiber such as rayon, a synthetic fiber, or a mixture thereof can be used. In addition, as the polymer having a hydroxyl group, any of natural, semi-synthetic, synthetic materials, or a mixture thereof may be used, and preferably, cellulose or hemicellulose may be used.

Returning to FIG. 15, the sealing member 570 prevents the liquid substance from scattering from the inside to the outside of the exterior case 560 and prevents the foreign matter from entering from the outside to the inside of the exterior case 560. Therefore, the sealing member 570 has high airtightness and has appropriate elasticity to ensure adhesion to the lead terminals 580 and 590, and a material able to maintain a performance related to the airtightness and the elasticity in a high temperature state or a low temperature state is selected. As such a sealing member 570, for example, a rubber material such as ethylene propylene terpolymer (EPT), isobutylene isoprene rubber (IIR), EPT-IIR blend rubber, and silicone rubber, or a rubber composite material in which a resin such as a phenol resin, an epoxy resin, and a fluororesin and a rubber are bonded to each other can be used, and preferably, IIR, which is a material having excellent airtightness, is used.

In addition, as shown in FIG. 17, in the capacitor element 550, the electrolyte 556 is filled in a gap between the anode foil 552 and the cathode foil 553 except for the separator 551. The electrolyte 556 contains the solid electrolyte 557 and the liquid substance 558. FIG. 17 is an enlarged view of a main portion of the capacitor element 550 included in the capacitor 532, and is an enlarged schematic cross-sectional view of a portion including the electrolyte 556 held by the separator 551 between the anode foil 552 and the cathode foil 553 included in the capacitor element 550. The schematic cross-sectional view illustrated in FIG. 17 is merely an example, and the present disclosure is not limited to the embodiment illustrated in FIG. 17.

As shown in FIG. 17, the surface of the anode foil 552 and the surface of the cathode foil 553 are roughened to form a pit in order to increase a specific surface area. In the example illustrated in FIG. 17, a case where wavy pits are formed on the surfaces of the anode foil 552 and the cathode foil 553 is exemplified, but formation of the pits is not limited thereto. The oxide film 554 is formed at the surface of the anode foil 552 in which the pit is formed by a chemical conversion treatment, and the oxide film 555 is formed at the surface of the cathode foil 553 in which the pit is formed by natural oxidation or the chemical conversion treatment. Here, in FIG. 17, a cross-section of the fiber constituting the separator 551 is illustrated as the separator 551.

The solid electrolyte 557 formed of a particulate conductive polymer compound is filled in the gap between the anode foil 552 and the cathode foil 553 except for the separator 551. The conductive polymer compound which is the solid electrolyte 557 forms a solid electrolyte phase by aggregating particles. Here, the solid electrolyte phase containing the conductive polymer compound, which is the solid electrolyte 557, may contain an additive (not illustrated) in addition to the conductive polymer compound. In addition, in the following description, the gap between the anode foil 552 and the cathode foil 553 except for the separator 551 may be referred to as a first gap.

The liquid substance 558 is introduced into a remaining gap in the first gap occupied by the solid electrolyte 557. Here, in FIG. 17, the liquid substance 558 is illustrated as a hatching region. The liquid substance 558 constitutes a liquid substance phase by being present so as to surround the solid electrolyte 557. In the electrolyte 556, a solid electrolyte phase containing a solid electrolyte 557 and a liquid substance phase containing a liquid substance 558 are present as separate phases. Here, the phrase “are present as separate phases” is not limited to a case where each is completely separated, and the solid electrolyte phase containing the solid electrolyte 557 and the liquid substance phase containing the liquid substance 558 may mutually intrude or may be mixed in a boundary region between the solid electrolyte phase and the liquid substance phase. In addition, in the following description, the remaining gap in the first gap occupied by the solid electrolyte 557 may be referred to as a second gap. It is preferable that the second gap is fully filled with the liquid substance phase containing the liquid substance 558, thereby wetting the surface of the anode foil 552 and the surface of the cathode foil 553, or a large number of the liquid substance phase is interposed between the solid electrolyte 557 and the separator 551, but the second gap may not be fully filled with the liquid substance phase containing the liquid substance 558.

Here, the solid electrolyte phase containing the solid electrolyte 557 and the liquid substance phase containing the liquid substance 558 included in the electrolyte 556 will be described.

The conductive polymer compound which is the solid electrolyte 557 constituting the solid electrolyte phase is, for example, a π-electron conjugated polymer compound, and is mainly an electron and hole conductive polymer compound containing a dopant in order to suitably exhibit or improve conductivity.

As the conductive polymer compound that is such a solid electrolyte 557, for example, polypyrrole, poly(N-methylpyrrole), polyaniline, polythiophene, poly(3-methylthiophene), poly(3,4-ethylenedioxythiophene), polyethylenedioxythiophene (PEDOT), poly(p-phenylene), polyfluorene, poly(p-phenylenevinylene), polythienylenevinylene, and the like can be used. In addition, as the dopant, for example, an anion such as toluenesulfonic acid, alkylbenzenesulfonic acid, naphthalenesulfonic acid, polyvinylsulfonic acid, polyarylsulfonic acid, polyacrylsulfonic acid, polymethacrylsulfonic acid, polyisoprenesulfonic acid, polystyrenesulfonic acid (PSS), and polyacrylic acid can be used.

The conductive polymer compound containing the solid electrolyte 557 can be introduced between the anode foil 552 and the cathode foil 553 by, for example, a chemical polymerization type method in which a monomer and a polymerization initiator (a dopant and an oxidizing agent, a catalyst, or the like) are coated on an electrode foil or impregnated between electrode foils and polymerized to adhere and form a conductive polymer layer on the electrode foil, a dispersion type method in which an element formed by winding an electrode foil and a separator is impregnated with an aqueous dispersion of a particulate conductive polymer and water is evaporated to fill the conductive polymer between electrode foils, a solution type method in which an element is impregnated with a solution obtained by dissolving a self-doped conductive polymer compound and dried to fill the conductive polymer between electrode foils, or the like.

In addition, as described above, the solid electrolyte phase may contain an additive in combination with the conductive polymer compound containing the solid electrolyte 557. The additive contained in the solid electrolyte phase is a component added when the conductive polymer compound is synthesized or when the conductive polymer dispersion is formulated for the purpose of improving characteristics such as the conductivity of the conductive polymer compound as the solid electrolyte 557, for the purpose of repairing defects of the oxide film, or for other purposes. As such an additive, for example, a conductivity improving agent, an ion conductive compound, an alkaline (basic) compound (pH adjusting agent), a water-soluble compound, a water-dispersible compound, and the like can be used.

The liquid substance phase containing the liquid substance 558 is liquid at a usage temperature or at least a part of the usage temperature, is present so as to surround the solid electrolyte phase in the second gap, and is a phase containing a liquid substance having a function of improving or complementing a function of the solid electrolyte 557, and is a functional liquid phase. Since such a liquid substance phase is a liquid phase regardless of a type of a substance, the liquid substance phase can be introduced after a formation process of the solid electrolyte phase unlike additives contained in the solid electrolyte phase, and can be introduced in a large amount to a fine portion between the separator 551 and the solid electrolyte phase. In addition, since the liquid substance phase is at least a liquid phase, the liquid substance phase can preferably exist between the separator 551 and the solid electrolyte phase, and has a function of reducing a deterioration reaction of the separator 551 due to a dopant liberated from the solid electrolyte phase. Such a liquid substance phase can have various useful functions by the liquid substance 558 containing specific components.

As the liquid substance 558 constituting the liquid substance phase, a simple organic solvent, in particular, a polymer organic solvent may be used as a liquid having the above-described minimum function, but preferably, for example, in addition to an electrolytic solution, a hydrophilic polymer compound, a component having a hydroxyl group, for example, polyoxyalkylene and a derivative thereof (polyglycerin), a water-soluble polyurethane, a water-soluble polyester, a water-soluble polyamide, a water-soluble polyimide, a water-soluble polyacryl, a water-soluble polyacrylamide, a water-soluble silicone, polyvinyl alcohol, polyacrylic acid, or the like, or a mixture thereof can be used.

In addition, a representative function of the liquid substance phase suitably includes a repair function of an oxide film. The repair of the oxide film can be achieved by, in addition to the electrolytic solution, for example, a hydrophilic polymer compound, a component having a hydroxyl group, for example, polyoxyalkylene and a derivative thereof (polyglycerin), a water-soluble polyurethane, a water-soluble polyester, a water-soluble polyamide, a water-soluble polyimide, a water-soluble polyacryl, a water-soluble polyacrylamide, polyvinyl alcohol, polyacrylic acid, a water-soluble silicone, and the like.

A function of repairing a defect of an oxide film by an electrolytic solution is known, but, for example, when a liquid substance phase contains a hydrophilic polymer compound, the hydrophilic polymer compound can retain moisture, and thus the defect of the oxide film can be preferably repaired by the retained moisture. The defect of the oxide film may occur when the capacitor 532 is manufactured or when the capacitor 532 is used for a long time, but in any case, the oxide film can be repaired when the moisture retained by the hydrophilic polymer compound reacts with an electrode foil metal of a defective portion. As a result, the capacitor 532 having a high withstand voltage, a low leakage current, and a long life can be obtained.

Here, in the present embodiment, the liquid substance phase refers to a phase that is liquid, particularly, at an atmospheric pressure and room temperature, for example, 1 atm and 25° C., but may be a liquid at a usage temperature or a part thereof. In addition, the liquid may be a substance having fluidity, and may be a substance having viscosity. Since the liquid substance phase is in a liquid state, a fine portion of the second gap that is the remaining gap of the separator 551 between the electrode foils and the solid electrolyte phase can be impregnated and filled with the liquid substance phase. Since the liquid substance phase can be introduced into the fine portion of the second gap, the liquid substance phase can be introduced in a larger amount, the liquid substance phase can be distributed to the fine portion of the second gap, and an active ingredient can reliably reach a portion where the repair of the oxide film and other functions are required.

In addition, the hydrophilic polymer compound that may be contained in the liquid substance phase is a polymer compound having a hydrophilic group, and examples of representative hydrophilic groups include a hydroxyl group, an ether bond, an amino group, a carbonyl group, a carboxyl group, a nitro group, a sulfonic acid group, an amide group, a phosphoric acid ester group, and the like. However, even when the hydrophilic polymer compound has a sulfonic acid group or the like, the hydrophilic polymer compound is a component different from a dopant doped in the conductive polymer compound, and the hydrophilic polymer compound and the dopant are distinguished depending on doping. In the present disclosure, the hydrophilic polymer compound does not contain a dopant. The number of hydrophilic groups in such a hydrophilic polymer compound may be 1 or more, and may be 2 or more. Furthermore, the number may be 3 or more, 4 or more, 5 or more, 6 or more, or even more. The more the number of hydrophilic groups, the higher the ability to retain water, and from this viewpoint, the larger the number of hydrophilic groups, the more preferable, but from the viewpoint of the handling properties of an oxide film repairing agent such as viscosity and a hygroscopic property, and cost, excessive hydrophilic groups are not desirable.

In addition, the hydrophilic polymer compound may be, for example, a polymer compound such as polyalkylene oxide, polyalkenylene oxide, polyphenylene oxide, water-soluble polyacryl, water-soluble polyurethane, water-soluble polyester, water-soluble polyamide, water-soluble polyimide, water-soluble silicone, branched polyether, polyglycerin, and derivatives thereof. In addition, water-soluble polyacryl, water-soluble polyurethane, water-soluble polyester, water-soluble polyamide, water-soluble polyimide, and water-soluble silicone may be, for example, polyurethane, polyester, polyamide, polyimide, and silicone in which a sulfonic acid group is introduced.

As described above, the capacitor element 550 included in the capacitor 532 of the present embodiment is configured such that the separator 551 is positioned between the anode foil 552 and the cathode foil 553, the solid electrolyte phase containing the conductive polymer compound that is the solid electrolyte 557 is positioned in the first gap between the anode foil 552 and the cathode foil 553 in which the separator 551 is not positioned, and the liquid substance phase containing the liquid substance 558 is positioned in the second gap in which the conductive polymer compound that is the solid electrolyte 557 is not positioned in the first gap. That is, the capacitor 532 includes the anode foil 552 in which the oxide film 554 is formed on a surface, the cathode foil 553, the separator 551 between the anode foil 552 and the cathode foil 553, and the electrolyte 556 existing in the first gap except for the separator 551 between the anode foil 552 and the cathode foil 553, and the electrolyte 556 includes a solid electrolyte phase containing the solid electrolyte 557 and a liquid substance phase containing the liquid substance 558 existing so as to surround the solid electrolyte 557.

As a result, in the capacitor 532 of the present embodiment, since the solid electrolyte phase containing the solid electrolyte 557 and the liquid substance phase containing the liquid substance 558 are contained as the electrolyte 556, the reliability of the capacitor 532 can be improved by the repair function of the oxide film by the liquid substance phase containing the liquid substance 558, and the low ESR characteristic of the capacitor 532 can be realized by the conductive polymer as the solid electrolyte 557. Since the low ESR characteristic of the capacitor 532 can be realized, the voltage amplitude of the ripple voltage superimposed on the power supply voltage signal VHV output by the smoothing circuit 53 including the capacitor 532 can be reduced. That is, since the power supply circuit 50 includes the capacitor 532 having the above-described configuration, the reliability of the power supply circuit 50 can be improved, and the ripple voltage superimposed on the power supply voltage signal VHV output by the power supply circuit 50 can be reduced. As a result, the operational stability of each portion to which the power supply voltage signal VHV is supplied is improved, and the operational stability of the liquid ejection apparatus 1 is improved.

In addition, since the capacitor 532 contains the solid electrolyte phase containing the solid electrolyte 557 as the electrolyte 556, a fluctuation of the ESR due to a temperature change can be reduced, and a difference between an ESR that is a DC resistance component of the capacitor 532 when a frequency is 100 kHz and a temperature is 0° C., and an ESR that is a DC resistance component of the capacitor 532 when the frequency is 100 kHz and the temperature is 80° C. can be set to 100 mΩ or less. In the power supply circuit 50 including the capacitor 532 and the liquid ejection apparatus 1 including the power supply circuit 50, even when the environmental temperature changes, a concern that the ripple voltage superimposed on the power supply voltage signal VHV to be output fluctuates can be reduced. That is, in the power supply circuit 50 and the liquid ejection apparatus 1 including the power supply circuit 50, even when the environmental temperature changes, a concern that the ripple voltage superimposed on the power supply voltage signal VHV increases can be reduced. As a result, the operational stability of each portion to which the power supply voltage signal VHV is supplied is further improved, and the operational stability of the liquid ejection apparatus 1 is improved.

Here, the ejection unit 5 corresponds to a liquid ejection unit. The power supply circuit 50 is an example of a power supply circuit, the capacitor 532 included in the smoothing circuit 53 is an example of a capacitor, the oxide film 554 formed at the surface of the anode foil 552 is an example of an oxide film, and the first gap is a gap except for the separator 551 between the anode foil 552 and the cathode foil 553, and is an example of a gap portion. In addition, the detection circuit 23 is an example of a residual vibration detection circuit, the AD conversion circuit 231 is an example of an AD conversion circuit, the switch Wc[m] is an example of a first switch circuit, the switch Ws[m] is an example of a second switch circuit, and the coupling member 17 is an example of a BtoB connector. In addition, the power supply voltage signal VDC is an example of a first power supply voltage signal, the power supply voltage signal VHV is an example of a second power supply voltage signal, the detection potential signal VX is an example of a residual vibration signal, and the detection signal SK is an example of a residual vibration detection signal.

### 4. Operational Effects

As described above, in the liquid ejection apparatus 1 and the ejection unit 5 of the present embodiment, the power supply circuit 50 to which the power supply voltage signal VDC is input and which outputs the power supply voltage signal VHV to the switches Wc[1] to Wc[M] and Ws[1] to Ws[M] is configured as a switching power supply circuit including the switching circuit 52 that outputs the pulse signal corresponding to the power supply voltage signal VDC, and the smoothing circuit 53 that includes the capacitor 532 and outputs the power supply voltage signal VHV obtained by smoothing the pulse signal. In the liquid ejection apparatus 1 and the ejection unit 5 of the present embodiment, the capacitor 532 included in the smoothing circuit 53 of the power supply circuit 50 configured as a switching power supply circuit includes the anode foil 552 in which the oxide film 554 is formed at the surface, the cathode foil 553, the separator 551 between the anode foil 552 and the cathode foil 553, and the electrolyte 556 existing in the first gap except for the separator 551 between the anode foil 552 and the cathode foil 553, and the electrolyte 556 includes a solid electrolyte phase containing the solid electrolyte 557 and a liquid substance phase containing the liquid substance 558 existing so as to surround the solid electrolyte 557.

In such a capacitor 532, the reliability of the capacitor 532 can be improved by the repair function of the oxide film by the liquid substance phase containing the liquid substance 558, and the low ESR characteristic of the capacitor 532 can be realized by the conductive polymer as the solid electrolyte 557. Since the low ESR characteristic of the capacitor 532 can be realized, the voltage amplitude of the ripple voltage superimposed on the power supply voltage signal VHV output by the smoothing circuit 53 including the capacitor 532 can be reduced. That is, since the power supply circuit 50 includes the capacitor 532 having the above-described configuration, the reliability of the power supply circuit 50 can be improved, and the ripple voltage superimposed on the power supply voltage signal VHV output by the power supply circuit 50 can be reduced. As a result, the operational stability of each portion to which the power supply voltage signal VHV is supplied is improved, and the operational stability of the liquid ejection apparatus 1 is improved.

In addition, in the liquid ejection apparatus 1 and the ejection unit 5 of the present embodiment, since the capacitor 532 included in the smoothing circuit 53 of the power supply circuit 50 configured as a switching power supply circuit includes the anode foil 552 in which the oxide film 554 is formed at a surface, the cathode foil 553, the separator 551 between the anode foil 552 and the cathode foil 553, and the electrolyte 556 existing in the first gap except for the separator 551 between the anode foil 552 and the cathode foil 553, and the electrolyte 556 includes the solid electrolyte phase containing the solid electrolyte 557 and the liquid substance phase containing the liquid substance 558 existing so as to surround the solid electrolyte 557, a fluctuation of the ESR due to a temperature change can be reduced, and a difference between an ESR that is a DC resistance component of the capacitor 532 when a frequency is 100 kHz and a temperature is 0° C., and an ESR that is a DC resistance component of the capacitor 532 when the frequency is 100 kHz and the temperature is 80° C. can be set to 100 mΩ or less.

In the power supply circuit 50 including the capacitor 532 and the liquid ejection apparatus 1 including the power supply circuit 50, even when a temperature of the liquid ejection apparatus 1, the ejection unit 5, and each portion of the liquid ejection apparatus including the power supply circuit 50 changes, a concern that the ripple voltage superimposed on the power supply voltage signal VHV to be output fluctuates can be reduced. That is, in the power supply circuit 50 and the liquid ejection apparatus 1 including the power supply circuit 50, even when the temperature changes, a concern that the ripple voltage superimposed on the power supply voltage signal VHV increases can be reduced. As a result, the operational stability of each portion to which the power supply voltage signal VHV is supplied is further improved, and the operational stability of the liquid ejection apparatus 1 is improved.

In the liquid ejection apparatus 1 and the ejection unit 5 of the present embodiment, the switches Ws[1] to Ws[M] to which the power supply voltage signal VHV is supplied switch whether or not to supply the detection potential signal VX to the detection circuit 23. That is, a signal corresponding to the residual vibration having a small voltage amplitude propagates to the switches Ws[1] to Ws[M]. Even in such a case, in the liquid ejection apparatus 1 and the ejection unit 5 of the present embodiment, the ripple voltage superimposed on the power supply voltage signal VHV is reduced, and thus a concern that the ripple voltage superimposed on the power supply voltage signal VHV contributes to a signal corresponding to the residual vibration propagating through the switches Ws[1] to Ws[M] via a parasitic capacitance and the like included in the switches Ws[1] to Ws[M] is reduced. As a result, the waveform accuracy of the detection potential signal VX acquired by the detection circuit 23 is improved, and the accuracy of the detection signal SK output by the detection circuit 23 is improved. Therefore, the determination accuracy in the determination circuit 60 that determines the state of the ejection portion D that is an inspection target in correspondence with the detection signal SK is improved, and the operational stability of the liquid ejection apparatus 1 is further improved.

### 5. Modification Example

Here, in the present embodiment, description is made on the assumption that the piezoelectric element PZ is driven to eject ink from the ejection portion D and a signal corresponding to the residual vibration generated in the ejection portion D is output, but the ejection portion D may individually include a piezoelectric element as a drive element for ejecting ink and a piezoelectric element as a detection element for detecting the residual vibration generated in the ejection portion D. In addition, at this time, the drive element for ejecting the ink in the ejection portion D is not limited to the piezoelectric element as long as the element can convert an electric signal into a mechanical vibration, and the detection element for detecting the residual vibration generated in the ejection portion D is not limited to the piezoelectric element as long as the element can convert the mechanical vibration into an electric signal.

In the present embodiment, the description is made on the assumption that a potential generated in the upper electrode Zu of the piezoelectric element PZ is output as a signal corresponding to the residual vibration generated in the ejection portion D, but a potential generated in the lower electrode Zd of the piezoelectric element PZ may be output as a signal corresponding to the residual vibration generated in the ejection portion D.

In addition, the signal corresponding to the residual vibration generated in the ejection portion D may be a signal in which a current vibrates in correspondence with the residual vibration generated in the ejection portion D, or may be a signal in which a voltage vibrates in correspondence with the residual vibration generated in the ejection portion D. Therefore, the detection circuit 23 may be configured to detect a voltage value of a signal corresponding to the residual vibration generated in the ejection portion D, or may be configured to detect a current value of the signal corresponding to the residual vibration generated in the ejection portion D.

In addition, in the present embodiment, description is made on the assumption that the signal waveform of the drive signal Com output by the drive circuit 40 is switched between the drive waveforms PP1 and PP2, the drive waveform PS, and the drive waveform PC, but the drive circuit 40 may individually include an amplifier circuit that outputs the drive waveforms PP1 and PP2, an amplifier circuit that outputs the drive waveform PS, and an amplifier circuit that outputs the drive waveform PC.

Hitherto, the embodiments and the modification examples are described, but the present disclosure is not limited to the embodiments, and can be implemented in various aspects within the scope not departing from the concept of the present disclosure. For example, the above-described embodiments can also be appropriately combined with each other.

The present disclosure includes substantially the same configurations (for example, configurations having the same functions, methods, and results, or configurations having the same objects and effects) as the configurations described in the embodiments. Further, the present disclosure includes configurations in which non-essential parts of the configuration described in the embodiments are replaced. In addition, the present disclosure includes configurations that achieve the same operational effects or configurations that can achieve the same objects as those of the configurations described in the embodiments. Further, the present disclosure includes configurations in which a known technology is added to the configurations described in the embodiments.

The following contents are derived from the above-described embodiments.

According to an aspect, there is provided a liquid ejection apparatus including:
a transport portion that transports a medium;
an ejection portion that ejects a liquid to the medium by being supplied with a drive signal;
a first switch circuit that switches whether or not to supply the drive signal to the ejection portion; and
a power supply circuit to which a first power supply voltage signal is input and which outputs a second power supply voltage signal to the first switch circuit, in which
the power supply circuit includes
   a switching circuit that outputs a pulse signal corresponding to the first power supply voltage signal, and
   a smoothing circuit that includes a capacitor and outputs the second power supply voltage signal obtained by smoothing the pulse signal,
the capacitor includes an anode foil in which an oxide film is formed at a surface, a cathode foil, a separator disposed between the anode foil and the cathode foil, and an electrolyte existing in a gap portion except for the separator between the anode foil and the cathode foil, and
the electrolyte includes a solid electrolyte phase containing a conductive polymer compound, and a liquid substance phase that exists so as to surround the solid electrolyte phase and contains a liquid substance.

In the liquid ejection apparatus, in the power supply circuit, since the capacitor included in the smoothing circuit that smooths the pulse signal corresponding to the first power supply voltage signal output by the switching circuit and outputs the smoothed pulse signal as the second power supply voltage signal includes the anode foil in which the oxide film is formed at the surface, the cathode foil, the separator disposed between the anode foil and the cathode foil, and the electrolyte existing in the gap portion except for the separator between the anode foil and the cathode foil, and the electrolyte includes the solid electrolyte phase containing the conductive polymer compound and the liquid substance phase containing the liquid substance that exists so as to surround the solid electrolyte phase, the ESR that is a DC resistance component generated in the capacitor can be reduced. As a result, the power supply circuit can reduce the voltage amplitude of the ripple voltage superimposed on the second power supply voltage signal output by smoothing the pulse signal. Therefore, the operational stability of each portion of the liquid ejection apparatus including the first switch circuit that operates with the supply of the second power supply voltage signal is improved. That is, the stability of the operation of the liquid ejection apparatus is improved.

In the liquid ejection apparatus according to the aspect,
a difference between a DC resistance component of the capacitor when a frequency is 100 kHz and a temperature is 0° C. and a DC resistance component of the capacitor when the frequency is 100 kHz and the temperature is 80° C. may be 100 mΩ or less.

In the liquid ejection apparatus, since the capacitor included in the smoothing circuit that outputs the second power supply voltage signal includes the anode foil in which the oxide film is formed at the surface, the cathode foil, the separator disposed between the anode foil and the cathode foil, and the electrolyte existing in the gap portion except for the separator between the anode foil and the cathode foil, and the electrolyte includes the solid electrolyte phase containing the conductive polymer compound and the liquid substance phase containing the liquid substance that exists so as to surround the solid electrolyte phase, the difference between the DC resistance component of the capacitor when the frequency is 100 kHz and the temperature is 0° C. and the DC resistance component of the capacitor when the frequency is 100 kHz and the temperature is 80° C. can be set to 100 mΩ or less. As a result, a concern that the voltage amplitude of the ripple voltage superimposed on the second power supply voltage signal output by smoothing the pulse signal by the power supply circuit fluctuates depending on the temperature can be reduced. Therefore, the operational stability of each portion of the liquid ejection apparatus including the first switch circuit that operates with the supply of the second power supply voltage signal is further improved, and the operational stability of the liquid ejection apparatus is further improved.

The liquid ejection apparatus according to the aspect may further include:
a print head including the ejection portion and the first switch circuit; and
a circuit substrate provided with the power supply circuit, in which
the print head and the circuit substrate may be electrically coupled via a BtoB connector.

The liquid ejection apparatus according to the aspect may further include:
a residual vibration detection circuit that acquires a residual vibration signal corresponding to a residual vibration generated in the ejection portion and outputs a residual vibration detection signal corresponding to the residual vibration signal;
a determination circuit that determines a state of the ejection portion in correspondence with the residual vibration detection signal; and
a second switch circuit that switches whether or not to supply the residual vibration signal to the residual vibration detection circuit, in which
the second power supply voltage signal may be supplied to the second switch circuit.

In this liquid ejection apparatus, the power supply circuit can reduce the voltage amplitude of the ripple voltage superimposed on the second power supply voltage signal output by smoothing the pulse signal. Therefore, the concern that the ripple voltage superimposed on the second power supply voltage signal contributes to the residual vibration signal corresponding to the residual vibration having a small voltage value is reduced. As a result, the state determination accuracy of the ejection portion in the determination circuit is improved.

In the liquid ejection apparatus according to the aspect,
the residual vibration detection circuit may include an AD conversion circuit and output the residual vibration detection signal that is a digital signal.

In the liquid ejection apparatus according to the aspect,
the residual vibration detection circuit may acquire an electromotive force generated by a displacement of a piezoelectric element in correspondence with the residual vibration as the residual vibration signal.

In the liquid ejection apparatus according to the aspect,
the ejection portion may eject the liquid by driving of the piezoelectric element.

According to another aspect, there is provided a liquid ejection unit including:
an ejection portion that ejects a liquid to a medium by being supplied with a drive signal;
a first switch circuit that switches whether or not to supply the drive signal to the ejection portion; and
a power supply circuit to which a first power supply voltage signal is input and which outputs a second power supply voltage signal to the first switch circuit, in which
the power supply circuit includes
   a switching circuit that outputs a pulse signal corresponding to the first power supply voltage signal, and
   a smoothing circuit that includes a capacitor and outputs the second power supply voltage signal obtained by smoothing the pulse signal,
the capacitor includes an anode foil in which an oxide film is formed at a surface, a cathode foil, a separator disposed between the anode foil and the cathode foil, and an electrolyte existing in a gap portion except for the separator between the anode foil and the cathode foil, and
the electrolyte includes a solid electrolyte phase containing a conductive polymer compound, and a liquid substance phase that exists so as to surround the solid electrolyte phase and contains a liquid substance.

In the liquid ejection unit, in the power supply circuit, since the capacitor included in the smoothing circuit that smooths the pulse signal corresponding to the first power supply voltage signal output by the switching circuit and outputs the smoothed pulse signal as the second power supply voltage signal includes the anode foil in which the oxide film is formed at the surface, the cathode foil, the separator disposed between the anode foil and the cathode foil, and the electrolyte existing in the gap portion except for the separator between the anode foil and the cathode foil, and the electrolyte includes the solid electrolyte phase containing the conductive polymer compound and the liquid substance phase containing the liquid substance that exists so as to surround the solid electrolyte phase, the ESR that is a DC resistance component generated in the capacitor can be reduced. As a result, the power supply circuit can reduce the voltage amplitude of the ripple voltage superimposed on the second power supply voltage signal output by smoothing the pulse signal. Therefore, the operational stability of each portion of the liquid ejection unit including the first switch circuit that operates with the supply of the second power supply voltage signal is improved.

In the liquid ejection unit according to the aspect,
a difference between a DC resistance component of the capacitor when a frequency is 100 kHz and a temperature is 0° C. and a DC resistance component of the capacitor when the frequency is 100 kHz and the temperature is 80° C. may be 100 mΩ or less.

In the liquid ejection unit, since the capacitor included in the smoothing circuit that outputs the second power supply voltage signal includes the anode foil in which the oxide film is formed at the surface, the cathode foil, the separator disposed between the anode foil and the cathode foil, and the electrolyte existing in the gap portion except for the separator between the anode foil and the cathode foil, and the electrolyte includes the solid electrolyte phase containing the conductive polymer compound and the liquid substance phase containing the liquid substance that exists so as to surround the solid electrolyte phase, the difference between the DC resistance component of the capacitor when the frequency is 100 kHz and the temperature is 0° C. and the DC resistance component of the capacitor when the frequency is 100 kHz and the temperature is 80° C. can be set to 100 mΩ or less. As a result, a concern that the voltage amplitude of the ripple voltage superimposed on the second power supply voltage signal output by smoothing the pulse signal by the power supply circuit fluctuates depending on the temperature can be reduced. Therefore, the operational stability of each portion of the liquid ejection unit including the first switch circuit that operates with the supply of the second power supply voltage signal is further improved.

The liquid ejection unit according to the aspect may further include:
a print head including the ejection portion and the first switch circuit; and
a circuit substrate provided with the power supply circuit, in which
the print head and the circuit substrate may be electrically coupled via a BtoB connector.

The liquid ejection unit according to the aspect may further include:
a residual vibration detection circuit that acquires a residual vibration signal corresponding to a residual vibration generated in the ejection portion and outputs a residual vibration detection signal corresponding to the residual vibration signal;
a determination circuit that determines a state of the ejection portion in correspondence with the residual vibration detection signal; and
a second switch circuit that switches whether or not to supply the residual vibration signal to the residual vibration detection circuit, in which
the second power supply voltage signal may be supplied to the second switch circuit.

In this liquid ejection unit, the power supply circuit can reduce the voltage amplitude of the ripple voltage superimposed on the second power supply voltage signal output by smoothing the pulse signal. Therefore, the concern that the ripple voltage superimposed on the second power supply voltage signal contributes to the residual vibration signal corresponding to the residual vibration having a small voltage value is reduced. As a result, the state determination accuracy of the ejection portion in the determination circuit is improved.

In the liquid ejection unit according to the aspect,
the residual vibration detection circuit may include an AD conversion circuit and output the residual vibration detection signal that is a digital signal.

In the liquid ejection unit according to the aspect,
the residual vibration detection circuit may acquire an electromotive force generated by a displacement of a piezoelectric element in correspondence with the residual vibration as the residual vibration signal.

In the liquid ejection unit according to the aspect,
the ejection portion may eject the liquid by driving of the piezoelectric element.

What is claimed is:

1. A liquid ejection apparatus comprising:
a transport portion that transports a medium;
an ejection portion that ejects a liquid to the medium by being supplied with a drive signal;
a first switch circuit that switches whether or not to supply the drive signal to the ejection portion; and
a power supply circuit to which a first power supply voltage signal is input and which outputs a second power supply voltage signal to the first switch circuit, wherein
the power supply circuit includes
a switching circuit that outputs a pulse signal corresponding to the first power supply voltage signal, and
a smoothing circuit that includes a capacitor and outputs the second power supply voltage signal obtained by smoothing the pulse signal,
the capacitor includes an anode foil in which an oxide film is formed at a surface, a cathode foil, a separator disposed between the anode foil and the cathode foil, and an electrolyte existing in a gap portion except for the separator between the anode foil and the cathode foil, and
the electrolyte includes a solid electrolyte phase containing a conductive polymer compound, and a liquid substance phase that exists so as to surround the solid electrolyte phase and contains a liquid substance.

2. The liquid ejection apparatus according to claim 1, wherein
a difference between a DC resistance component of the capacitor when a frequency is 100 kHz and a temperature is 0° C. and a DC resistance component of the capacitor when the frequency is 100 kHz and the temperature is 80° C. is 100 mΩ or less.

3. The liquid ejection apparatus according to claim 1, further comprising:
a print head including the ejection portion and the first switch circuit; and
a circuit substrate provided with the power supply circuit, wherein
the print head and the circuit substrate are electrically coupled via a BtoB connector.

4. The liquid ejection apparatus according to claim 1, further comprising:
a residual vibration detection circuit that acquires a residual vibration signal corresponding to a residual vibration generated in the ejection portion and outputs a residual vibration detection signal corresponding to the residual vibration signal;
a determination circuit that determines a state of the ejection portion in correspondence with the residual vibration detection signal; and
a second switch circuit that switches whether or not to supply the residual vibration signal to the residual vibration detection circuit, wherein
the second power supply voltage signal is supplied to the second switch circuit.

5. The liquid ejection apparatus according to claim 4, wherein
the residual vibration detection circuit includes an AD conversion circuit and outputs the residual vibration detection signal that is a digital signal.

6. The liquid ejection apparatus according to claim 4, wherein
the residual vibration detection circuit acquires an electromotive force generated by a displacement of a piezoelectric element in correspondence with the residual vibration as the residual vibration signal.

7. The liquid ejection apparatus according to claim 6, wherein
the ejection portion ejects the liquid by driving of the piezoelectric element.

8. A liquid ejection unit comprising:
an ejection portion that ejects a liquid to a medium by being supplied with a drive signal;
a first switch circuit that switches whether or not to supply the drive signal to the ejection portion; and
a power supply circuit to which a first power supply voltage signal is input and which outputs a second power supply voltage signal to the first switch circuit, wherein
the power supply circuit includes
a switching circuit that outputs a pulse signal corresponding to the first power supply voltage signal, and
a smoothing circuit that includes a capacitor and outputs the second power supply voltage signal obtained by smoothing the pulse signal,
the capacitor includes an anode foil in which an oxide film is formed at a surface, a cathode foil, a separator disposed between the anode foil and the cathode foil, and an electrolyte existing in a gap portion except for the separator between the anode foil and the cathode foil, and
the electrolyte includes a solid electrolyte phase containing a conductive polymer compound, and a liquid substance phase that exists so as to surround the solid electrolyte phase and contains a liquid substance.

9. The liquid ejection unit according to claim 8, wherein
a difference between a DC resistance component of the capacitor when a frequency is 100 kHz and a temperature is 0° C. and a DC resistance component of the capacitor when the frequency is 100 kHz and the temperature is 80° C. is 100 mΩ or less.

10. The liquid ejection unit according to claim 8, further comprising:
a print head including the ejection portion and the first switch circuit; and
a circuit substrate provided with the power supply circuit, wherein
the print head and the circuit substrate are electrically coupled via a BtoB connector.

11. The liquid ejection unit according to claim 8, further comprising:
a residual vibration detection circuit that acquires a residual vibration signal corresponding to a residual vibration generated in the ejection portion and outputs a residual vibration detection signal corresponding to the residual vibration signal;
a determination circuit that determines a state of the ejection portion in correspondence with the residual vibration detection signal; and
a second switch circuit that switches whether or not to supply the residual vibration signal to the residual vibration detection circuit, wherein
the second power supply voltage signal is supplied to the second switch circuit.

12. The liquid ejection unit according to claim 11, wherein
the residual vibration detection circuit includes an AD conversion circuit and outputs the residual vibration detection signal that is a digital signal.

13. The liquid ejection unit according to claim 11, wherein
the residual vibration detection circuit acquires an electromotive force generated by a displacement of a piezoelectric element in correspondence with the residual vibration as the residual vibration signal.

14. The liquid ejection unit according to claim 13, wherein
the ejection portion ejects the liquid by driving of the piezoelectric element.
